(19) United States
(12) Patent Application Publication
(10) Pub. No.: US 2026/0268328 A1
(43) Pub. Date: Sep. 10, 2026

(54) AUTHENTICATION SYSTEM, AND USER AUTHORIZATION SYSTEM

(71) Applicant: Vlightup Inc., Chiyoda-ku, Tokyo (JP)

(72) Inventor: Sachio MINAMOTO, Tokyo (JP)

(73) Assignee: Vlightup Inc., Chiyoda-ku, Tokyo (JP)

(21) Appl. No.: 19/489,245

(22) PCT Filed: May 30, 2024
(86) PCT No.: PCT/JP2024/019877

§ 371 Date: Dec. 1, 2025

(30) Foreign Application Priority Data
Jun. 2, 2023 (JP) 2023-091794
Jun. 2, 2023 (JP) 2023-091795

(51) Int. Cl. G06Q 20/40

(52) U.S. Cl. CPC G06Q 20/4015; G06Q 20/4014

(57) ABSTRACT

The present disclosure provides an authentication system or the like capable of avoiding unauthorized use in applications such as hacking of a user's account, spoofing or hijacking in a given network service while taking into consideration the acquisition of personal information. The authentication server 30 has a configuration that can determine the authentication of the specific user by using the difference between the current position and the past position, not the position of the specific user itself, when executing authentication process of authenticating that a given action of the network service is being executed by a legitimate user.

### TECHNICAL FIELD

The present invention relates to an authentication system, a network service provision system, a user authorization system, an authentication method, a method for providing network services, and a user authorization method.

### BACKGROUND ART

In recent years, illegal use represented by so-called spoofing has been increasing rapidly in services such as Internet banking services and online stores via the world wide web (WWW).

Further, in recent years, the development of blockchain technology has not only increased the popularity of crypto-assets such as bitcoin as investment targets and speculation targets but also increased the use of such crypto-assets in commercial transactions such as electronic commerce in place of the legal tender.

However, in recent years, the use of crypto-assets has become a hotbed of money-laundering and illegal transactions, and therefore, in the electronic commerce (e-commerce) based on the crypto-assets, a commercial transaction method that registering the address of the recipient of the crypto-assets is required (for example, the Japan Virtual and Crypto assets Exchange Association, “Notice on Correspondence to Travel Rules in Self-Regulatory Rule determined by the Association”, [online], Mar. 1, 2022 [retrieved on Dec. 20, 2022], Internet <https://jvcea.or.jp/news/main-info/20220301-001/>).

In order to prevent such illegal transactions, a technique for monitoring illegal transactions also appear (for example, Japanese Patent Application Publication No. 2022-514612).

Recently, for example, a technique is known for detecting unauthorized access based on information on the user's operation when the user accesses a Web site providing various services on the Internet using an ID and a password.

As a typical example, a system is known which determines the presence or absence of an illegal use using position information when accessing a Web site using an ID and a password (i.e., when performing personal authentication) (for example, Japanese Patent Application Publication No. 2012-3299).

### SUMMARY OF THE INVENTION

### Problem to be Solved by the Invention

However, in the system of Japanese Patent Application Publication No. 2012-3299, since the unauthorized access is monitored by acquiring the personal information of the user, especially, the position information, there is room for improvement from the viewpoint of the protection of the personal information.

Further, with the method of the commercial transactions described in the “Notice on Correspondence to Travel Rules in Self-Regulatory Rule determined by the Association”, it is difficult to prevent the money-laundering or the illegal transactions when the sender or receiver of the crypto-assets is an illegal user, even if the address of the receiver of the crypto-assets is registered.

In the system of Japanese Patent Application Publication No. 2022-514612, also the unauthorized access is monitored by acquiring the personal information of the user, especially, the position information. In the same way, there is room for improvement from the viewpoint of the protection of the personal information.

The present invention is made to solve the above problems and provides an authentication system or the like capable of avoiding unauthorized use in applications such as hacking of a user's account, spoofing or hijacking in a given network service while taking into consideration the acquisition of personal information.

Also, the present invention is made to solve the above problems, and provides an electronic commerce authentication system which is used for fair trade, authentic transactions and highly reliable transactions in electronic commerce (e-commerce) using the crypto-assets while taking into consideration the acquisition of personal information.

### Solution to the Problem

(1) In order to solve the above problem, an authentication system according to a first aspect of the present invention, for authenticating a given action when a user is enabled to receive a given network service, the authentication system has:
a management unit for managing reference distance related information, which is information registered in advance in a storage unit and in which a reference distance for authenticating an execution of the action by the user or information related to the reference distance is defined;
an identification unit for identifying a user who instructs the execution of the action as a specific user based on user information relating to a user who executes the action when the action is executed;
a determination processing unit for executing a determination process of determining whether the specific user when the action is executed satisfies a given user condition; and
an authentication processing unit for executing an authentication process of authenticating the execution of the action based on a result of the determination process at an action execution timing at which the action is executed,
wherein the determination processing unit executes, as the determination process:
   a position information acquisition process of acquiring difference information at an action execution timing or an action execution related timing related to the action execution timing, the difference information indicating a difference between a current position of the specific user at the action execution timing or the action execution related timing and a position of the specific user at a past timing; and
   a condition determination process of comparing the acquired difference information and the reference distance related information, and of determining whether the result of the comparison satisfies a given user condition.

(2) In order to solve the above problem, an authentication method according to a second aspect of the present invention for authenticating a given action when a user is enabled to receive a given network service, the authentication method has:
managing reference distance related information, which is information registered in advance in a storage unit and in which a reference distance for authenticating an execution of the action by the user or information related to the reference distance is defined;
identifying a user who instructs the execution of the action as a specific user based on user information relating to a user who executes the action when the action is executed;
executing a determination process of determining whether the specific user when the action is executed satisfies a given user condition; and
executing an authentication process of authenticating the execution of the action based on a result of the determination process at an action execution timing at which the action is executed,
wherein the determination process includes:
   a position information acquisition process of acquiring difference information at an action execution timing or an action execution related timing related to the action execution timing, the difference information indicating a difference between a current position of the specific user at the action execution timing or the action execution related timing and a position of the specific user at a past timing; and
   a condition determination process of comparing the acquired difference information and the reference distance related information, and of determining whether the result of the comparison satisfies a given user condition.

Based on this configuration, the authentication method according to a second aspect of the present invention can determine whether a specific user is the authorized party by using the difference between the current position and the past position, not by using the position of the specific user itself.

Therefore, the authentication method according to a second aspect of the present invention can avoid unauthorized use in applications such as hacking, spoofing or hijacking of a user's account in a given network service while taking into consideration the acquisition of personal information.

(3) In order to solve the above problem, a network service provision system according to a third aspect of the present invention for providing a user with a given network service including that a given action is authenticated when a user is enabled to receive the network service, the network service provision system has:
a management unit for managing reference distance related information, which is information registered in advance in a storage unit and in which a reference distance for authenticating an execution of the action by the user or information related to the reference distance is defined;
an identification unit for identifying a user who instructs the execution of the action as a specific user based on user information relating to a user who executes the action when the action is executed;
a determination processing unit for executing a determination process of determining whether the specific user when the action is executed satisfies a given user condition; and
an authentication processing unit for executing an authentication process of authenticating the execution of the action based on a result of the determination process at an action execution timing at which the action is executed,
wherein the determination processing unit executes, as the determination process:
   a position information acquisition process of acquiring difference information at an action execution timing or an action execution related timing related to the action execution timing, the difference information indicating a difference between a current position of the specific user at the action execution timing or the action execution related timing and a position of the specific user at a past timing; and
   a condition determination process of comparing the acquired difference information and the reference distance related information, and of determining whether the result of the comparison satisfies a given user condition.

(4) In order to solve the above problem, a method for providing network services according to a fourth aspect of the present invention for providing a user with a given network service including that a given action is authenticated when a user is enabled to receive the network service, the method has:
managing reference distance related information, which is information registered in advance in a storage unit and in which a reference distance for authenticating an execution of the action by the user or information related to the reference distance is defined;
identifying a user who instructs the execution of the action as a specific user based on user information relating to a user who executes the action when the action is executed;
executing a determination process of determining whether the specific user when the action is executed satisfies a given user condition; and
executing an authentication process of authenticating the execution of the action based on a result of the determination process at an action execution timing at which the action is executed,
wherein the determination process includes:
   a position information acquisition process of acquiring difference information at an action execution timing or an action execution related timing related to the action execution timing, the difference information indicating a difference between a current position of the specific user at the action execution timing or the action execution related timing and a position of the specific user at a past timing; and
   a condition determination process of comparing the acquired difference information and the reference distance related information, and of determining whether the result of the comparison satisfies a given user condition.

(5) In order to solve the above problem, a user authorization system according to a fifth aspect of the present invention for executing determination relating to a user for a given action when a user is enabled to receive a given network service, the user authorization system has:
a management unit for managing reference distance related information, which is information registered in advance in a storage unit and in which a reference distance for authenticating an execution of the action by the user or information related to the reference distance is defined;
an identification unit for identifying a user who instructs the execution of the action as a specific user based on user information relating to a user who executes the action when the action is executed;
a determination processing unit for executing a determination process of determining whether the specific user when the action is executed satisfies a given user condition; and
a provision unit for providing a determination result of the determination process to an information processing device,
wherein the determination processing unit executes:
   a position information acquisition process of acquiring difference information at an action execution timing or an action execution related timing related to the action execution timing, the difference information indicating a difference between a current position of the specific user at the action execution timing or the action execution related timing and a position of the specific user at a past timing; and
   a condition determination process of comparing the acquired difference information and the reference distance related information, and of determining whether the result of the comparison satisfies a given user condition.

(6) In order to solve the above problem, a user authorization method according to a sixth aspect of the present invention for executing determination relating to a user for a given action when a user is enabled to receive a given network service, the user authorization method has:
managing reference distance related information, which is information registered in advance in a storage unit and in which a reference distance for authenticating an execution of the action by the user or information related to the reference distance is defined;
identifying a user who instructs the execution of the action as a specific user based on user information relating to a user who executes the action when the action is executed;
executing a determination process of determining whether the specific user when the action is executed satisfies a given user condition; and
a provision unit for providing a determination result of the determination process to an information processing device,
wherein the determination process includes:
   a position information acquisition process of acquiring difference information at an action execution timing or an action execution related timing related to the action execution timing, the difference information indicating a difference between a current position of the specific user at the action execution timing or the action execution related timing and a position of the specific user at a past timing; and
   a condition determination process of comparing the acquired difference information and the reference distance related information, and of determining whether the result of the comparison satisfies a given user condition.

(7) In order to solve the above problem, an authentication system according to a seventh aspect of the present invention for executing authentication to log in to a given network service for a user, the authentication system has:
a management unit for managing reference distance related information, which is information registered in advance in a storage unit and in which a reference distance for authenticating login of the user or information related to the reference distance is defined;
an identification unit for identifying a user who instructs the execution of the action as a specific user based on user information relating to a user who executes the login;
a determination processing unit for executing a determination process of determining whether the specific user when the login is executed satisfies a given user condition; and
an authentication processing unit for executing an authentication process of authenticating the execution of the login based on a result of the determination process at a login execution at which the login is executed,
wherein the determination processing unit executes, as the determination process:
   a position information acquisition process of acquiring difference information at a login execution timing or a login execution related timing related to the login execution timing, the difference information indicating a difference between a current position of the specific user at the login timing or the login execution related timing and a position of the specific user at a past timing; and
   a condition determination process of comparing the acquired difference information and the reference distance related information, and of determining whether the result of the comparison satisfies a given user condition.

(8) In order to solve the above problem, an authentication method according to an eighth aspect of the present invention for authenticating a given action when a user is enabled to receive a given network service, has:
managing reference distance related information, which is information registered in advance in a storage unit and in which a reference distance for authenticating an execution of the action by the user or information related to the reference distance is defined;
identifying a user who instructs the execution of the action as a specific user based on user information relating to a user who executes the action when the action is executed;
executing a determination process of determining whether the specific user when the action is executed satisfies a given user condition; and
executing an authentication process of authenticating the execution of the action based on a result of the determination process at an action execution timing at which the action is executed,
wherein the determination process includes:
   a position information acquisition process of acquiring difference information at an action execution timing or an action execution related timing related to the action execution timing, the difference information indicating a difference between a current position of the specific user at the action execution timing or the action execution related timing at position of the specific user at a past timing; and
   a condition determination process of comparing the acquired difference information and the reference distance related information, and of determining whether the result of the comparison satisfies a given user condition.

### BRIEF DESCRIPTION OF DRAWINGS

FIG. 1 is a system configuration diagram illustrating a network service provision system according to a first embodiment.

FIG. 2 is a functional block diagram illustrating an example of a configuration of a service management server according to the first embodiment.

FIG. 3 is a functional block diagram illustrating an example of a configuration of an authentication server according to the first embodiment.

FIG. 4 is a diagram for explaining an authentication process and an authenticity determination process as a determination criterion of the authentication process executed by the authentication server according to the first embodiment.

FIG. 5 is a diagram illustrating an example of reference distance related information stored in a position related information storage unit according to the first embodiment.

FIG. 6 is a flowchart illustrating the operation of the authentication process executed by the authentication server of the first embodiment.

FIG. 7 is a system configuration diagram illustrating a network service provision system of a first modification according to the first embodiment.

FIG. 8 is a diagram for explaining the authentication process executed by the authentication server when a given action is executed on a terminal device in the first modification according to the first embodiment.

FIG. 9 is a system configuration diagram illustrating a network service provision system of a second modification according to the first embodiment.

FIG. 10 is a system configuration diagram illustrating a network service provision system of a seventh modification according to the first embodiment.

FIG. 11 is a system configuration diagram illustrating an electronic commerce system according to a second embodiment.

FIG. 12 is a functional block diagram illustrating an example of a configuration of a commercial transactions management server according to the second embodiment.

FIG. 13 is a diagram for explaining an authentication process executed by the authentication server with each process relating to electronic commerce executed by the authentication server, the authentication process according to the second embodiment.

FIG. 14 is a flowchart illustrating the operation of the authentication process executed by the authentication server of the second embodiment.

FIG. 15 is a system configuration diagram illustrating the electronic commerce system according to the second embodiment.

FIG. 16 is a diagram for explaining the authentication process executed by the authentication server of the first modification according to the first embodiment.

FIG. 17 is a system configuration diagram illustrating the electronic commerce system of the second modification according to a second embodiment.

FIG. 18 is a system configuration diagram illustrating the electronic commerce system of the seventh modification according to the second embodiment.

### DETAILED DESCRIPTION OF THE EMBODIMENT

(1) In order to solve the above problem, an authentication system according to a first embodiment of the present invention is an authentication system for authenticating a given action when a user is enabled to receive a given network service, and has:
a management unit for managing reference distance related information, which is information registered in advance in a storage unit and in which a reference distance for authenticating an execution of the action by the user or information related to the reference distance is defined;
an identification unit for identifying a user who instructs the execution of the action as a specific user based on user information relating to a user who executes the action when the action is executed;
a determination processing unit for executing a determination process of determining whether the specific user when the action is executed satisfies a given user condition; and
an authentication processing unit for executing an authentication process of authenticating the execution of the action based on a result of the determination process at an action execution timing at which the action is executed,
wherein the determination processing unit executes, as the determination process:
   a position information acquisition process of acquiring difference information at an action execution timing or an action execution related timing related to the action execution timing, the difference information indicating a difference between a current position of the specific user at the action execution timing or the action execution related timing and a position of the specific user at a past timing; and
   a condition determination process of comparing the acquired difference information and the reference distance related information, and of determining whether the result of the comparison satisfies a given user condition.

Based on this configuration, the first embodiment of the present invention can determine whether a specific user is an authorized party by using the difference between the current position and the past position, not by using the position of the specific user itself.

Therefore, the first embodiment of the present invention can avoid unauthorized use in applications such as hacking, spoofing or hijacking of a user's account in a given network service while taking into consideration the acquisition of personal information.

The “network services” include providing services to the user using the network, the providing services indicating that banking services, which are financial institution services; reservation services for restaurants, hotels, and transportation; product sales services; SNS; services for providing content such as games, music, and videos; and information providing services including search and advertising.

The “action” is a process executed by a user's instruction or a program, and indicates a process relating to the network service, such as reservation of a service, execution or cancellation of purchase of a commodity, upload or transmission of a comment or an image to another user, download of data of a moving image or a photograph, or use of an application.

The “user information” is information such as a user ID registered in advance or the user ID and a user password.

The “specifying the user as a specific user” indicates that:
(A1) in a dedicated server different from a service providing server providing a network service for the specific user, or the terminal device, the specific user is specified based on the user ID transmitted from the service providing server or terminal device; or
(A2) in the service providing server, the specific user is specified based on the user ID of the user logged in the service providing server.

The recitation “reference distance related information in which a reference distance for authenticating the execution of the user's action or information related to the distance is defined” is information indicating a proper difference (a positional difference that can identify the user) of the user when each user moves from a position where the user existed in the past.

For example, the “reference distance related information” may be differences in latitude and longitude or distance between two points. In the case of an area or a country is long from the east to west or north to south, the latitude and longitude may be either one of the latitude and longitude as long as one of the latitude and longitude can be limited.

The “reference distance related information” may be information on a height, and for example, indicates information is a difference between the previous ground height and the current ground height.

The “action execution related timing” includes, for example, an arbitrary timing designated by the user, a random timing, a timing before the action execution timing arrives, and a timing that arrives at each predetermined period.

For example, the “position distance information” may be differences in latitude and longitude or distance between two points. In the case of an area or a country that is long from the east to west or north to south, the latitude and longitude may be either one of the latitude and longitude as long as one of the latitude and longitude can be limited. The “determination process” includes a process of determining the validity of a procedure (instruction) for authentication of an action to be executed, or an authentication process of performing user authentication.

The “user condition” includes a condition that the position difference of the specific user is within the distance range of the reference distance related information registered as the specific user, for example.

(2) In the first embodiment of the present invention,
the determination processing unit:
   acquires difference information indicating a difference between the current position of the specific user and the position of the specific user at a past timing, at each timing predetermined as an action execution related timing, as the position information acquisition process;
   registers the acquired difference information in a storage unit as recorded information of the corresponding user; and
   executes the condition determination process of comparing the recorded information of the specific user with the reference distance related information, and of determining whether the comparison result satisfies the user condition.

Based on this configuration, the first embodiment of the present invention can determine whether a specific user is the authorized party by using the difference between the current position and the past position, while taking into consideration the acquisition of personal information when the action is executed.

The “at each predetermined timing” includes once a day or a week, or at each time a user logs in to the network service for performing electronic commerce.

The “condition determination process” indicates a process of performing based on determining a condition that the position difference of the position difference information acquired at each predetermined timing is within the distance range of the reference distance related information registered as the transaction target in addition to or in place of the above user condition.

(3) In the first embodiment of the present invention,
the determination processing unit:
   acquires difference information indicating a difference between the current position of the specific user and the position of the specific user at a past timing, at each timing predetermined as an action execution related timing, as the position information acquisition process;
   registers the acquired difference information in a storage unit as recorded information of the corresponding user; and
   executes the condition determination process of comparing the recorded information of the specific user with the reference distance related information, and of determining whether the comparison result satisfies the user condition, before the action execution timing or a timing after the action is executed.

Based on this configuration, the first embodiment of the present invention can determine whether a specific user is the authorized party before or after the execution of the action in the network service. Therefore, in the network service in which the action timing is important, the time for the authentication process can be simplified, and as a result, the user can perform the action accurately at the desired timing.

The recitation, “before the action execution timing” is not limited to the timing as long as it is before the execution timing at which the action is executed.

(4) In the first embodiment of the present invention,
the determination processing unit executes the determination process of determining authenticity of the specific user when the action is executed based on the determination result of the condition determination process as the determination process.

Based on this configuration, the first embodiment of the present invention can determine the validity (i.e., authenticity) of the procedure (instruction) for authentication of the action as the specific user and therefore can execute the authentication process of performing user authentication based on the position information.

(5) In the first embodiment of the present invention,
the determination process unit:
   acquires, as the position information acquisition process, time information indicating a time at the action execution timing or the action execution related timing when the difference information is acquired; and
   determines, as the condition determination process, whether the difference information based on the time information satisfies the user condition with respect to the reference distance related information.

Based on this configuration, the first embodiment of the present invention can recognize the time when the position difference occurs and therefore can detect irrational movement such as a long-distance movement of a transaction target in a moment.

Therefore, the first embodiment of the present invention can more reliably determine whether the movement range (i.e., activity range) of the specific user is reasonable and thus can avoid unauthorized use in applications such as hijacking, spoofing, or hacking of the user's account in a given network service while taking into consideration the acquisition of personal information.

The “time information” includes, for example, information indicating a date synchronized with location information such as GPS, information indicating a date and time, or information indicating a time.

(6) The first embodiment of the present invention further has a provision unit for providing the user with an execution result of the action.

Based on this configuration, the first embodiment of the present invention can provide the user with the result of the execution of the action, and therefore, the user can be made to recognize whether the action can be executed.

(7) In the first embodiment of the present invention,

In the case where an electronic commerce is executed as the action, and the reference distance related information has: information of a distance serving as a reference for authenticating the electronic commerce; or information related to the distance,
the identification unit identifies, as the specific user, a transaction target person who conducts the electronic commerce based on transaction target person information that relates to a transaction target person who is at least one user of a supplier and a client of the electronic commerce, and that is transmitted from an information processing device executing the electronic commerce, and
the authentication process unit executes the authentication process of authenticating the electronic commerce between the identified supplier and the client based on the determination result of the determination process at a transaction execution timing at which the electronic commerce is executed as the action execution timing; and
the determination process unit
   executes the information acquisition process of acquiring position difference information indicating a difference between a current position of the transaction target person at a timing corresponding to the transaction execution timing or a transaction execution related timing related to the transaction execution timing and a position of the transaction target person at a past timing, at the transaction execution timing or the transaction execution related timing; and
   compares the acquired position difference information with the reference distance related information and executes the condition determination process of determining whether the result of the comparison satisfies a transaction target person condition that indicates the user condition.

Based on this configuration, the first embodiment of the present invention can determine whether a supplier or a customer is an authorized party by using the difference between the current position and the past position, not by using the position of the specific user itself.

In other words, the first embodiment of the present invention can prevent risks, such as:
(A1) disadvantages due to the absence of a central administrator for crypto assets (lack of stability due to value guarantees for fiat currencies, etc.);
(A2) reduction of the credibility risk of business transactions based on non-face-to-face transactions (reduction of the reliability of information such as whether the transaction source and the business partner exist); and
(A3) the occurrence of illegal transactions based on such reduced credit risk (exploitation of assets and funds or their use for money laundering), in the electronic commerce using a crypto-asset, while taking into consideration the acquisition of personal information.

Therefore, the first embodiment of the present invention can achieve the fair trade, authentic transactions and highly reliable transactions in the electronic commerce using the crypto-assets, while taking into consideration the acquisition of personal information.

The recitation “Crypto-assets” indicate property values that can be exchanged over networks such as the Internet and are assets that can be used for payment of goods in commercial transactions, can be exchanged with legal tender, and can be electronically recorded and transferred.

For example, Bitcoin, Ethereum and the like are known as typical crypto-assets. Additionally, the “crypto-assets” in this embodiment may include the legal tender (the electronic legal tender) issued in digital form such as “yen”, “dollar”, “euro”, or “yuan”.

The electronic commerce indicates conducting commercial transactions such as the sale of products or services, exchanging crypto-assets as consideration for products or services, or exchanging crypto-assets for legal tender as consideration for the acquisition of crypto-assets (i.e., a commercial transaction to sell or buy crypto-assets themselves) by electronic means on a network or computer.

The “supplier” is a user who conducts a transaction to provide the transaction object or offer the transaction, such as a product or service in the electronic commerce, and the “client” is a user who conducts a transaction to obtain a proposed transaction object in exchange for payment of a price in the electronic commerce.

The “information processing device” may be a terminal device owned by the user, or a server used for mediating the electronic commerce (so-called server having a function of an exchange).

The “transaction target person information” is, for example, information such as a user ID registered in advance or the user ID and the user password.

The phrase “identify the transaction target person” indicates that:
(B1) in a dedicated server different from a service providing server executing the electronic commerce, or the terminal device, the user is specified based on the user ID transmitted from the service providing server or terminal device; or
(B2) in the server of an electronic commerce system executing the electronic commerce, the user is specified based on the user ID of the user logged in the server.

The recitation “reference distance related information in which a reference distance for authenticating the commercial transactions or information related to the distance is defined” is information indicating a proper difference (a positional difference that can identify the user) of the user when each user moves from a position where the user existed in the past.

For example, the “reference distance related information” may be differences in latitude and longitude or distance between two points. In the case of an area a country is long from the east to west or north to south, the latitude and longitude may be either one of the latitude and longitude as long as one of the latitude and longitude can be limited.

The “reference distance related information” may be information on a height, and for example, indicates information is a difference between the previous ground height and the current ground height.

The “transaction execution related timing” includes, for example, an arbitrary timing designated by the user, a random timing, a timing before the transaction execution timing arrives, and a timing that arrives at each predetermined period.

The “transaction target person's condition” includes, for example, a condition that the position difference at the time of authentication of the supplier or the customer is within the distance range of the reference distance related information registered in association with the transaction target person.

(8) In the first embodiment of the present invention,
the determination processing unit:
   acquires, as the difference information, a position difference information indicating a difference between the current position of the transaction target person and the position of the transaction target person at a past timing, at each timing predetermined as the transaction execution related timing, as the position information acquisition process;
   registers the acquired difference information in a storage unit as recorded information of the corresponding transaction target person; and
   executes the condition determination process of comparing the recorded information of the transaction target person with the reference distance related information, and of determining whether the comparison result satisfies the transaction target person condition.

Based on this configuration, the first embodiment of the present invention can determine whether the transaction target person such as the supplier or the customer is the authorized party by using the difference between the current position and the past position, while taking into consideration the acquisition of personal information when authenticating the electronic commerce.

The “at each timing predetermined” includes once a day or a week, or each time a user logs in to the network service for performing electronic commerce.

The “condition determination process” indicates a process of performing based on determining a condition that the position difference of the position difference information acquired at each predetermined timing is within the distance range of the reference distance related information registered as the transaction target, in addition to or in place of the above transaction target person condition.

(9) In the embodiment of the present invention,
the information processing device registers the information relating to the electronic commerce as electronic commerce information in a plurality of databases in a distributed manner, and
the electronic commerce information is formed by block information which is blocked based on a plurality of pieces of electronic commerce information including the electronic commerce information and a hash value determined from past electronic commerce information when the electronic commerce is authenticated.

Based on this configuration, the first embodiment of the present invention can register the electronic commerce information in a plurality of databases or the like by using a distributed ledger technology such as a blockchain which is difficult to be falsified.

(10) In order to solve the above problem, the second embodiment of the present invention is an authentication method for authenticating a given action when a user is enabled to receive a given network service, and has:
managing reference distance related information, which is information registered in advance in a storage unit and in which a reference distance for authenticating an execution of the action by the user or information related to the reference distance is defined;
identifying a user who instructs the execution of the action as a specific user based on user information relating to a user who executes the action when the action is executed;
executing a determination process of determining whether the specific user when the action is executed satisfies a given user condition; and
executing an authentication process of authenticating the execution of the action based on a result of the determination process at an action execution timing at which the action is executed,
wherein the determination process includes:
   a position information acquisition process of acquiring difference information at an action execution timing or an action execution related timing related to the action execution timing, the difference information indicating a difference between a current position of the specific user at the action execution timing or the action execution related timing at position of the specific user at a past timing; and
   a condition determination process of comparing the acquired difference information and the reference distance related information, and of determining whether the result of the comparison satisfies a given user condition.

Based on this configuration, the second embodiment of the present invention can determine whether a specific user is the authorized party by using the difference between the current position and the past position, not by using the position of the specific user itself.

Therefore, the second embodiment of the present invention can avoid unauthorized use in applications such as hacking, spoofing or hijacking of a user's account in a given network service while taking into consideration the acquisition of personal information.

(11) In order to solve the above problem, the third embodiment of the present invention is a network service provision system for providing a user with a given network service including that a given action is authenticated when a user is enabled to receive the network service, and has:
a management unit for managing reference distance related information, which is information registered in advance in a storage unit and in which a reference distance for authenticating an execution of the action by the user or information related to the reference distance is defined;
an identification unit for identifying a user who instructs the execution of the action as a specific user based on user information relating to a user who executes the action when the action is executed;
a determination processing unit for executing a determination process of determining whether the specific user when the action is executed satisfies a given user condition; and
an authentication processing unit for executing an authentication process of authenticating the execution of the action based on a result of the determination process at an action execution timing at which the action is executed,
wherein the determination processing unit executes, as the determination process:
   a position information acquisition process of acquiring difference information at an action execution timing or an action execution related timing related to the action execution timing, the difference information indicating a difference between a current position of the specific user at the action execution timing or the action execution related timing at position of the specific user at a past timing; and
   a condition determination process of comparing the acquired difference information and the reference distance related information, and of determining whether the result of the comparison satisfies a given user condition.

Based on this configuration, the third embodiment of the present invention can determine whether a specific user is the authorized party by using the difference between the current position and the past position, not by using the position of the specific user itself.

Therefore, the third embodiment of the present invention can avoid unauthorized use in applications such as hacking, spoofing or hijacking of a user's account in a given network service while taking into consideration the acquisition of personal information.

(12) In the third embodiment of the present invention,
in the case where an electronic commerce is executed as the action, and the reference distance related information has: information of a distance serving as a reference for authenticating the electronic commerce; or information related to the distance,
the identification unit identifies a transaction target person who conducts the electronic commerce based on transaction target person information that relates to a transaction target person who is at least one user of a supplier and a client of the electronic commerce, and that is transmitted from an information processing device executing the electronic commerce as the specific user, and
the authentication process unit executes the authentication process of authenticating the electronic commerce between the identified supplier and the client based on the determination result of the determination process at a transaction execution timing at which the electronic commerce is executed as the action execution timing; and
the determination process unit
   executes the information acquisition process of acquiring position difference information indicating a difference between a current position of the transaction target person at a timing corresponding to the transaction execution timing or a transaction execution related timing related to the transaction execution timing and a position of the transaction target person at a past timing, at the transaction execution timing or the transaction execution related timing; and
   compares the acquired difference information with the reference distance related information and executes the condition determination process of determining whether the result of the comparison satisfies a transaction target person condition that indicates the user condition.

Based on this configuration, the third embodiment of the present invention can determine whether a supplier or a customer is an authorized party by using the difference between the current position and the past position, not by using the position of the specific user itself.

Therefore, the third embodiment of the present invention can achieve the fair trade, authentic transactions and highly reliable transactions in the electronic commerce using the crypto-assets, while taking into consideration the acquisition of personal information.

(13) In order to solve the above problem, the fourth embodiment of the present invention is a method for providing network services for providing a user with a given network service including that a given action is authenticated when a user is enabled to receive the network service, and has:
managing reference distance related information, which is information registered in advance in a storage unit and in which a reference distance for authenticating an execution of the action by the user or information related to the reference distance is defined;
identifying a user who instructs the execution of the action as a specific user based on user information relating to a user who executes the action when the action is executed;
executing a determination process of determining whether the specific user when the action is executed satisfies a given user condition; and
executing an authentication process of authenticating the execution of the action based on a result of the determination process at an action execution timing at which the action is executed,
wherein the determination process includes:
   a position information acquisition process of acquiring difference information at an action execution timing or an action execution related timing related to the action execution timing, the difference information indicating a difference between a current position of the specific user at the action execution timing or the action execution related timing at position of the specific user at a past timing; and
   a condition determination process of comparing the acquired difference information and the reference distance related information, and of determining whether the result of the comparison satisfies a given user condition.

Based on this configuration, the fourth embodiment of the present invention can determine whether a specific user is the authorized party by using the difference between the current position and the past position, not by using the position of the specific user itself.

Therefore, the fourth embodiment of the present invention can avoid unauthorized use in applications such as hacking, spoofing or hijacking of a user's account in a given network service while taking into consideration the acquisition of personal information.

(14) In order to solve the above problem, the fifth embodiment of the present invention is a user authorization system for executing determination relating to a user for a given action when a user is enabled to receive a given network service, and has:
a management unit for managing reference distance related information, which is information registered in advance in a storage unit and in which a reference distance for authenticating an execution of the action by the user or information related to the reference distance is defined;
an identification unit for identifying a user who instructs the execution of the action as a specific user based on user information relating to a user who executes the action when the action is executed;
a determination processing unit for executing a determination process of determining whether the specific user when the action is executed satisfies a given user condition; and
a provision unit for providing a determination result of the determination process to an information processing device,
wherein the determination processing unit executes:
   a position information acquisition process of acquiring difference information at an action execution timing or an action execution related timing related to the action execution timing, the difference information indicating a difference between a current position of the specific user at the action execution timing or the action execution related timing at position of the specific user at a past timing; and
   a condition determination process of comparing the acquired difference information and the reference distance related information, and of determining whether the result of the comparison satisfies a given user condition.

Based on this configuration, the fifth embodiment of the present invention can determine whether a specific user is the authorized party by using the difference between the current position and the past position, not by using the position of the specific user itself.

Therefore, the fifth embodiment of the present invention can avoid unauthorized use in applications such as hacking, spoofing or hijacking of a user's account in a given network service while taking into consideration the acquisition of personal information.

The “information processing device” may be a terminal device owned by the user, or a server providing the network service.

(15) In the fifth embodiment of the present invention,
in the case where an electronic commerce is executed as the action, and the reference distance related information has: information of a distance serving as a reference for authenticating the electronic commerce; or information related to the distance,
the identification unit identifies a transaction target person who conducts the electronic commerce based on transaction target person information that relates to a transaction target person who is at least one user of a supplier and a client of the electronic commerce, and that is transmitted from an information processing device executing the electronic commerce as the specific user, and
the authentication process unit executes the authentication process of authenticating the electronic commerce between the identified supplier and the client based on the determination result of the determination process at a transaction execution timing at which the electronic commerce is executed as the action execution timing; and
the determination process unit
   executes the information acquisition process of acquiring position difference information indicating a difference between a current position of the transaction target person at a timing corresponding to the transaction execution timing or a transaction execution related timing related to the transaction execution timing and a position of the transaction target person at a past timing, at the transaction execution timing or the transaction execution related timing; and
   compares the acquired difference information with the reference distance related information and executes the condition determination process of determining whether the result of the comparison satisfies a transaction target person condition that indicates the user condition.

Based on this configuration, the fifth embodiment of the present invention can determine whether a supplier or a customer is an authorized party by using the difference between the current position and the past position, not by using the position of the specific user itself.

Therefore, the fifth embodiment of the present invention can achieve the fair trade, authentic transactions and highly reliable transactions in the electronic commerce using the crypto-assets, while taking into consideration the acquisition of personal information.

(16) In order to solve the above problem, the sixth embodiment of the present invention is a user authorization method for executing determination relating to a user for a given action when a user is enabled to receive a given network service, and has:
managing reference distance related information, which is information registered in advance in a storage unit and in which a reference distance for authenticating an execution of the action by the user or information related to the reference distance is defined;
identifying a user who instructs the execution of the action as a specific user based on user information relating to a user who executes the action when the action is executed;
executing a determination process of determining whether the specific user when the action is executed satisfies a given user condition; and
a provision unit for providing a determination result of the determination process to an information processing device,
wherein the determination process includes:
   a position information acquisition process of acquiring difference information at an action execution timing or an action execution related timing related to the action execution timing, the difference information indicating a difference between a current position of the specific user at the action execution timing or the action execution related timing at position of the specific user at a past timing; and
   a condition determination process of comparing the acquired difference information and the reference distance related information, and of determining whether the result of the comparison satisfies a given user condition.

Based on this configuration, the sixth embodiment of the present invention can determine whether a specific user is the authorized party by using the difference between the current position and the past position, not by using the position of the specific user itself.

Therefore, the sixth embodiment of the present invention can avoid unauthorized use in applications such as hacking, spoofing or hijacking of a user's account in a given network service while taking into consideration the acquisition of personal information.

(17) In order to solve the above problem, the seventh aspect of the present invention is an authentication system for executing authentication to log in to a given network service for a user, the authentication system has:
a management unit for managing reference distance related information, which is information registered in advance in a storage unit and in which a reference distance for authenticating login of the user or information related to the reference distance is defined;
an identification unit for identifying a user who instructs the execution of the action as a specific user based on user information relating to a user who executes the login;
a determination processing unit for executing a determination process of determining whether the specific user when the login is executed satisfies a given user condition; and
an authentication processing unit for executing an authentication process of authenticating the execution of the login based on a result of the determination process at a login execution at which the login is executed,
wherein the determination processing unit executes, as the determination process:
   a position information acquisition process of acquiring difference information at a login execution timing or a login execution related timing related to the login execution timing, the difference information indicating a difference between a current position of the specific user at the login timing or the login execution related timing and a position of the specific user at a past timing; and
   a condition determination process of comparing the acquired difference information and the reference distance related information, and of determining whether the result of the comparison satisfies a given user condition.

Based on this configuration, the seventh embodiment of the present invention can determine whether a specific user is the authorized party by using the difference between the current position and the past position, not by using the position of the specific user itself.

Therefore, the seventh embodiment of the present invention can avoid unauthorized use in applications such as hacking, spoofing or hijacking of a user's account in a given network service while taking into consideration the acquisition of personal information.

(18) In order to solve the above problem, the eighth embodiment of the present invention is an authentication method for executing authentication to log in to a given network service for a user, and has:
managing reference distance related information, which is information registered in advance in a storage unit and in which a reference distance for authenticating login of the user or information related to the reference distance is defined;
identifying a user who instructs the execution of the action as a specific user based on user information relating to a user who executes the login;
executing a determination process of determining whether the specific user when the login is executed satisfies a given user condition; and
executing an authentication process of authenticating the execution of the login based on a result of the determination process at a login execution at which the login is executed,
wherein the determination process includes:
   acquiring difference information at a login execution timing or a login execution related timing related to the login execution timing, the difference information indicating a difference between a current position of the specific user at the login timing or the login execution related timing and a position of the specific user at a past timing; and
   comparing the acquired difference information and the reference distance related information, and of determining whether the result of the comparison satisfies a given user condition.

Based on this configuration, the eighth embodiment of the present invention can determine whether a specific user is the authorized party by using the difference between the current position and the past position, not by using the position of the specific user itself.

Therefore, the eighth embodiment of the present invention can avoid unauthorized use in applications such as hacking, spoofing or hijacking of a user's account in a given network service while taking into consideration the acquisition of personal information.

Hereinafter, embodiments of the present invention will be described with reference to the drawings.

### [A1] Outline of Network Service Provision System

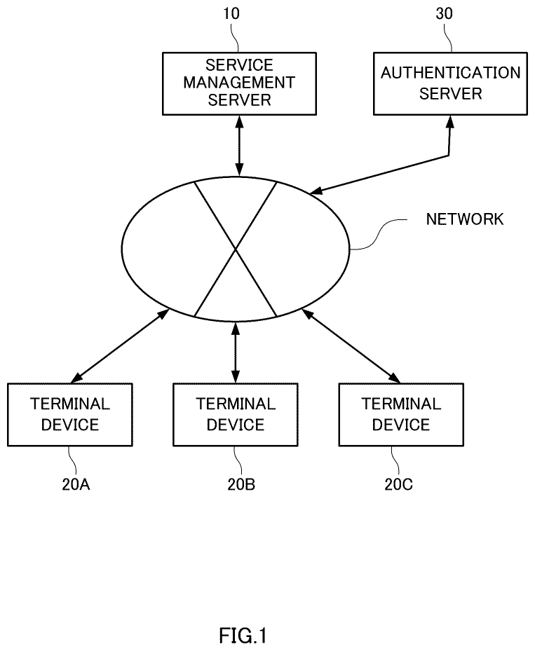

First, the outline and system configuration of a network service provision system S1 in the present embodiment will be described with reference to FIG. 1.

FIG. 1 is a system configuration diagram illustrating the network service provision system according to the present embodiment.

In order to prevent the drawings from becoming complicated, only some terminal devices 20 used by users are illustrated in FIG. 1. In other words, the network service provision system has more terminal devices 20 than shown on FIG. 1.

The following embodiment is an embodiment in which the authentication system and network service management system of the present application are applied to a network service provision system using a network, the network service provision system having a service management server for managing a network service, a terminal device used by a user who receives the network service, and an authentication server for authentication of an action of the network service.

Specifically, the network service of the present embodiment is described by taking, as an example, the sale of goods or the provision of services by electronic means on a network or a computer.

### (Outline of the System)

As illustrated in FIG. 1, the network service provision system S1 of the present embodiment is a system for providing a service (i.e., a network service) to a user by using a network.

The network service provision system S1 has a configuration for allowing the user to properly use the network service while avoiding unauthorized use of the network service, such as hijacking, spoofing, or hacking of the user's account.

The network service provision system S1 of the present embodiment is configured to provide the user with a banking service that provides a service of a financial institution, a reservation service for restaurants, hotels, transportation facilities, etc., a product sales service, an SNS, a content providing service for games, music, videos, etc., a cloud service such as various applications including e-mail and the like, or an information providing service including search and advertisement, etc., as network services.

### (System Configuration)

As illustrated in FIG. 1, the network service provision system S1 of the present embodiment has a service management server 10 for executing various processes for managing network services, terminal devices 20 (for example, terminal devices 20A, 20B, and 20C) connected to the service management server 10 via a network such as the Internet and used by users who receives the network services, and an authentication server 30 for executing various processes for authentication of the network services in conjunction with the service management server 10.

The service management server 10 is an information processing device that executes various processes for providing the network services to the user by using, for example, an API (application programming interface) or a predetermined platform.

The service management server 10 has a function for providing the service to a user, including a user's log-in to a network service, and a function for cooperating with each other in the case of communication between users.

The service management server 10 may be configured by one device (or processor) or a plurality of devices (or processors).

In the case of storing information on each network service used by the user, the service management server 10 may have a configuration in which the information is registered in a plurality of databases (not shown) using a distributed ledger technology such as a blockchain which is difficult to be falsified.

The terminal device 20 is a communication terminal device that serves as an information processing device used by users such as a PC (personal computer), a tablet-type information communication terminal device, a smart phone, a mobile phone and an HMD.

The terminal device 20 is connectable to the service management server 10 via a network such as the Internet (WAN) or a LAN, and has a configuration for establishing a communication line with the service management server 10 by wire or wireless to transmit and receive various data.

The terminal device 20 has a communication control function for communicating input information input by the user with service management server 10, a function for acquiring the current position of the user, and a display function for performing display control using data received from the service management server 10.

The authentication server 30 is an information processing device that executes various processes for authenticating a given action of the network services by using, for example, an API (application programming interface) or a predetermined platform.

The authentication server 30 may be configured by a single device or processor, or a plurality of devices or processors, as in the case of the authentication server 30.

The authentication server 30 is configured to execute an authentication process of authenticating the network service by determining whether the user is the authorized party based on the position difference information of the user.

### [A2] Service Management Server

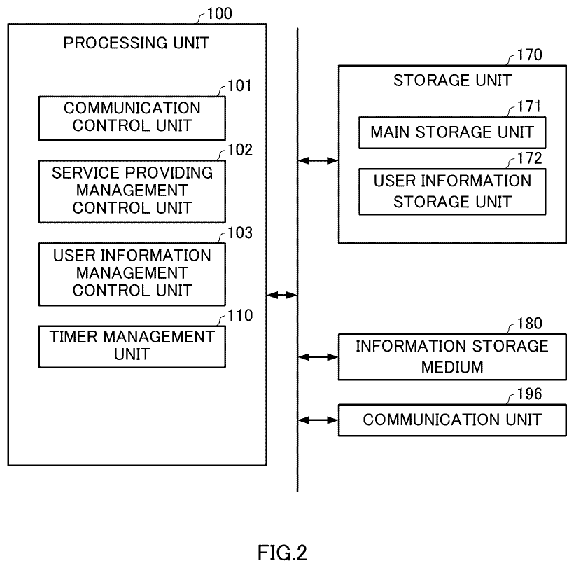

Next, the configuration according to the service management server 10 of the present embodiment will be described with reference to FIG. 2.

FIG. 2 is one example of a diagram illustrating functional blocks of the service management server 10 of the present embodiment.

As illustrated in FIG. 2, the service management server 10 of the present embodiment includes a processing unit 100, a storage unit 170, an information storage medium 180, and a communication unit 196.

The service management server 10 of the present embodiment may be configured by omitting one or more composing elements illustrated in FIG. 2.

The storage unit 170 serves as a work area for the processing unit 100, and the like, and its functions are configured by a RAM (VRAM) or the like.

Specifically, the storage unit 170 includes a main storage unit 171 used for a work area used when various processes are executed, and a user information storage unit 172 storing user information.

The storage unit 170 of the present embodiment may be configured such that a part of the configuration of the main storage unit 171 and the user information storage unit 172 is omitted.

The information storage medium 180 is readable by a computer, and programs, data, and the like are stored in the information storage medium 180. In other words, the information storage medium 180 stores programs for causing the computer to function as the respective units of the present embodiment (programs for causing the computer to execute the processing of the respective units).

The processing unit 100 can perform the various processes of the present embodiment based on data read out from programs (data) stored in the information storage medium 180.

For example, the information storage medium 180 is an optical disk (CD, DVD), a magneto-optical disk (MO), a magnetic disk, a hard disk, a flash memory such as a solid-state drive, a magnetic tape, a memory (ROM), or a memory card.

The communication unit 196 performs various controls to communicate with an external device (for example, the terminal device 20 or the authentication server 30). The functions of the communication unit 196 is configured by hardware of various processors or ASICs for communication, program and so on.

The processing unit 100 performs the various processes of the present embodiment based on programs (data) stored in the storage unit 170.

The processing unit 100 of the present embodiment may read out the program and data stored in the information storage medium 180, temporarily store the read-out program and data in the storage unit 170, and perform processing based on the program and data.

The processing unit 100 executes various processes using the main storage unit 171 in the storage unit 170 as a work area. The processing unit 100 is implemented by hardware such as various processors (CPU, DSP, etc.), and programs.

Specifically, the processing unit 100 includes a communication control unit 101, a service providing management control unit 102, a user information management control unit 103, and a timer management unit 110.

The communication control unit 101 establishes communication lines with the terminal device 20 and the authentication server 30 through the network and performs communication with each other.

The service providing management control unit 102 works the terminal devices 20 of the users and executes a process of managing the transaction.

The service providing management control unit 102 executes various processes such as login from the user and providing the various services described above.

Specifically, the service providing management control unit 102: works with the authentication server 30. When executing the action of the service, for example, the service providing management control unit 102 receives the result of the authentication processing of the authentication server 30, and executes each process relating to execution or suspension of the action based on the received result.

The user information management control unit 103 manages information of each user.

Specifically, the user information management control unit 103 manages, for example, registration and update of each piece of information required for logging in to the service and each piece of information required for providing the service in the user information storage unit 172.

The timer management unit 110 has a function of performing measurement from the current date and time or a predetermined timing, and outputs the current time or a measurement result when the predetermined timing is detected.

### [A3] Authentication Server

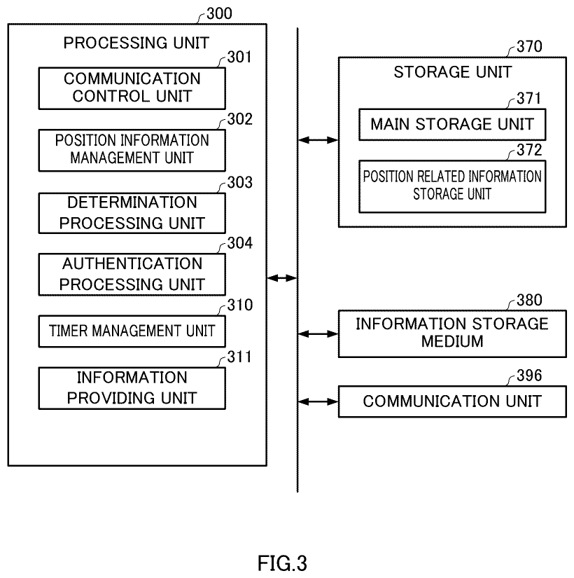

Next, the configuration according to the authentication server 30 of the present embodiment will be described with reference to FIG. 3.

FIG. 3 is one example of a diagram illustrating functional blocks of the authentication server 30 of the present embodiment.

As illustrated in FIG. 3, the authentication server 30 of the present embodiment includes a processing unit 300, a storage unit 370, an information storage medium 380, and a communication unit 396.

The authentication server 30 of the present embodiment may be configured by omitting one or more composing elements illustrated in FIG. 3.

The storage unit 370 serves as a work area for the processing unit 300, and the like, and its functions are configured by a RAM (VRAM) or the like.

The storage unit 370 includes: a main storage unit 371 used as a work area used when various processes are executed; and a position related information storage unit 372 that stores information on a reference distance or information related to the distance (hereinafter referred to as “reference distance related information”) for determining whether or not the user is the authorized party and information on the user's position acquired from the terminal device 20 at each predetermined timing (hereinafter referred to as “position related information”).

Specifically, the position related information storage unit 372 stores reference distance related information in which a reference distance for authentication of an action for a network service or information related to the distance is defined for each user of the network service in association with user identification information (UID) for each user.

The storage unit 370 of the present embodiment may be configured such that a part of the configuration having the main storage unit 371 and the position related information storage unit 372 is omitted.

The information storage medium 380 is readable by a computer, and programs, data, and the like are stored in the information storage medium 380. In other words, the information storage medium 380 stores programs for causing the computer to function as the respective units of the present embodiment (programs for causing the computer to execute the processing of the respective units).

The processing unit 300 can perform the various processes of the present embodiment based on data read out from programs (data) stored in the information storage medium 380.

For example, the information storage medium 380 is an optical disk (CD, DVD), a magneto-optical disk (MO), a magnetic disk, a hard disk, a flash memory such as a solid-state drive, a magnetic tape, a memory (ROM), or a memory card.

The communication unit 396 performs various controls to communicate with the service management server 10. The functions of the communication unit 396 is configured by hardware of various processors or ASICs for communication, program and so on.

The processing unit 300 performs the various processes of the present embodiment based on programs (data) stored in the storage unit 370. The processing unit 300 of the present embodiment may read out the program and data stored in the information storage medium 380, temporarily store the read-out program and data in the storage unit 370, and perform processing based on the program and data.

The processing unit 300 executes various processes using the main storage unit 371 in the storage unit 370 as a work area. The processing unit 300 is implemented with hardware such as various processors (CPU, DSP, etc.), and programs.

Specifically, the processing unit 300 includes a communication control unit 301, a position information management unit 302, a determination processing unit, and an authentication processing unit 304, a timer management unit 310, and an information providing unit 311.

The communication control unit 301 establishes communication lines with the service management server 10 through the network and performs communication with each other.

The position information management unit 302 manages reference distance related information of each user and position related information of each user transmitted from each terminal device 20 at each predetermined timing as recorded information.

The determination processing unit 303 executes a determination process (hereinafter referred to as “authenticity determination process”) for each user at a given timing, based on the corresponding reference distance related information, to determine whether the user (hereinafter referred to as “specific user”) who is instructing the execution of a given action on a network service is the authorized party (in other words, the true and correct party), the given timing being a timing such as the timing of executing the network service (hereinafter, referred to as “action execution timing”) and the timing associated with the action execution timing (hereinafter referred to as “action execution related timing”).

For example, the determination processing unit 303 executes authenticity determination process of determining the authenticity of the specific user who instructs execution of the action, which is executed by a user's instruction or a program, and which relates to the above network service, the action including execution or cancellation of reservation of a service or purchase of a commodity, upload or transmission of a comment or an image to another user, download of data of a video or a photograph.

When the action for the network service is executed, the authentication processing unit 304 executes an authentication process of determining whether to authenticate the action based on the result of the authenticity determination process.

The timer management unit 310 has a function of performing measurement from the current date and time or a predetermined timing, and outputs the current time or a measurement result when the predetermined timing is detected.

The information providing unit 311 provides the service management server 10 with authenticity determination result information indicating a determination result by the authenticity process.

### [A4] Method of the Present Embodiment

### [A4-1] Overview

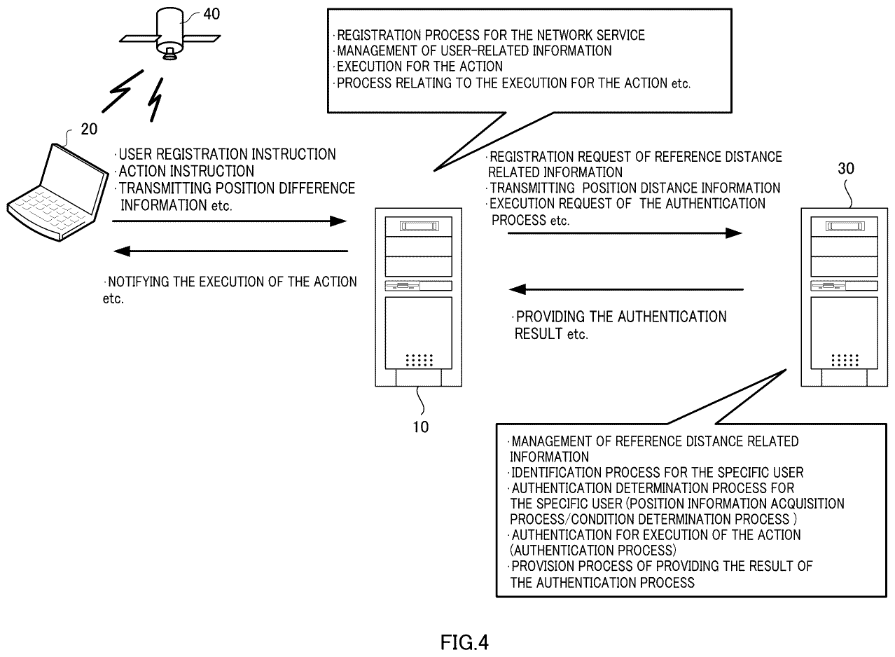

Next, the authentication process and the authenticity determination process which are executed by the authentication server 30 of the present embodiment will be described with reference to FIG. 4, the authenticity determination process serving as the basis for the authentication process.

FIG. 4 is a diagram for explaining an authentication process and an authenticity determination process as a determination criterion of the authentication process executed by the authentication server 30 according to the present embodiment.

The authentication server 30 of the present embodiment is configured to determine whether or not a specific user who instructs the execution of a given action of a network service is the authorized party (in other words, the true and correct party), at an action execution timing or an action execution related timing when a given action is executed in the network service of the service management server 10, and to execute an authentication process of authenticating the specific user is a legitimate user on the basis of the result of the determination.

The authentication server 30 of the present embodiment is an device for authenticating the execution of a given action in a network service, such as the execution or cancellation of a reservation of a service or purchase of a commodity, the upload or transmission of a comment or an image to another user, the download of data of a moving image or a photograph, or the use of an application, based on the position of a specific user when the action is executed.

On the other hand, the authentication server 30 of the present embodiment has a configuration for determining the authenticating of a specific user by using the difference between the positions of two points of the user acquired at a given timing, not the position of the user itself, in order to restrict the acquisition of personal information such as the position of the user.

The authentication server 30 of the present embodiment has a configuration that can determine the authenticity of the specific user by using the difference between the current position and the past position, not the position of the specific user itself, when executing authentication process of authenticating that a given action of the network service is being executed by a legitimate user.

Specifically, the authentication server 30 of the present embodiment has a configuration for managing reference distance related information which is registered in advance and serves as a reference for authenticating the action of a corresponding user, as illustrated in FIG. 4.

It is preferable that the reference distance related information is stored for each user who executes a given action of the network service and is stored in association with each user.

As illustrated in FIG. 4, the authentication server 30 is configured to identify the user who instructs execution of an action as a specific user based on user information relating to the user who executes the action when the action is executed.

As illustrated in FIG. 4, the authentication server 30 is configured: to execute a determination process (specifically, an authenticity determination process) for determining whether or not a specific user when an action is executed satisfies a given user condition; and to execute an authentication process of authenticating the execution of the action at an action execution timing when the action is executed based on the determination result of the authenticity determination process.

The authentication server 30, as illustrated in FIG. 4:
(A1) executing, at the action execution timing or the action execution related timing, a position information acquisition process of acquiring difference information indicating a difference between the current position of the specific user at the corresponding timing and the position of the specific user at a past timing;
(A2) executing a condition determination process of comparing the acquired difference information with reference distance related information of the specific user and determining whether the result of the comparison satisfies a given user condition.

As illustrated in FIG. 4, the authentication server 30 has a configuration for providing the result of the authentication process to the service management server 10.

FIG. 4 shows an example of a terminal device 20 that acquires position difference information specified from position information based on a GPS signal transmitted from a GPS satellite 40, transmits the acquired position difference information to an authentication server 30 via a service management server 10, transmits a registration instruction to a network service, transmits an execution instruction of the given action, receives the result of authentication process, and receives the execution result of the action.

Specifically, FIG. 4 shows an example in which a laptop is used as the terminal device 20.

FIG. 4 shows an example of the service management server 10 that performs registration process of the network service, management of user-related information used for executing each process relating to the network service, execution of a given action for the network service, and the process relating to the execution of the action.

FIG. 4 shows an example of the authentication server 30 that executes a registration request for the reference distance related information transmitted from the service management server 10, acquisition of the position difference information based on the current position of the terminal device 20, the identification process of the specific user, the authenticity determination process (the position information acquisition process and the condition determination process), the authentication process of authenticating execution of an action, and the provision process of providing the result of the authentication process.

The authentication server 30 of the present embodiment has such a configuration and thus can determine whether the specific user is the authorized party by using the difference between the current position and the past position, not the position of the specific user itself.

Therefore, the authentication server 30 of the present embodiment can avoid unauthorized use in applications such as hacking, spoofing or hijacking of a user's account in a given network service while taking into consideration the acquisition of personal information.

### [A4-2] Reference Distance Related Information and Position Difference Information

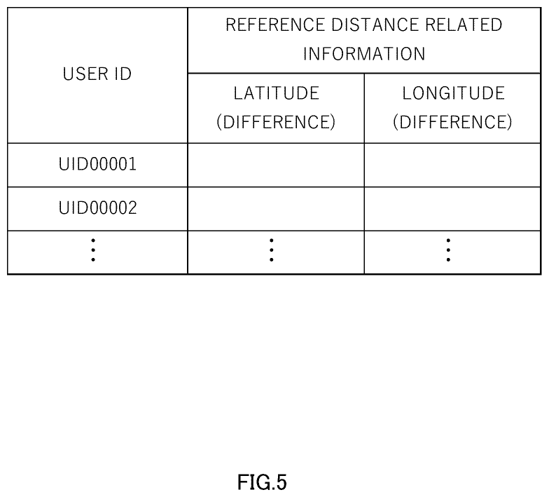

Next, the reference distance related information and the position difference information of the present embodiment will be described with reference to FIG. 5.

FIG. 5 is a diagram illustrating an example of the reference distance related information stored in the position related information storage unit according to the first embodiment.

### (Reference Distance Related Information)

The reference distance related information is information specifying a reference distance for determining the authenticity of a user who has instructed an action for a network service or information relating to the distance, and indicates the authenticity difference (positional difference that allows identification verification) of the user when each user moves from a position where the user existed in the past.

The reference distance related information is stored in the position related information storage unit 372 in association with user identification information (UID) for each user.

The reference distance related information is information that serves as a criterion for determining the authenticity of the use (i.e., the specific user) that has instructed the action for the network service and is information that defines the maximum movement range between two points of the trader that can be determined as the authenticity.

For example, the reference distance related information may be differences in latitude and longitude or distance between two points. In the case of an area of a country that is long from the east to west or north to south, the latitude and longitude may be either one of the latitude and longitude as long as one of the latitude and longitude can be limited.

The reference distance related information is stored in the position related information storage unit 372 for each user identification information under the operation input of the terminal device 20 of each user through the service management server 10 when the user newly registers in the network service.

For example, the reference distance related information activity location includes, as shown in FIG. 5:
(A1) a user ID (UID) as user identification information; and
(A2) the longitude and the latitude as the location of activity for reference.

The reference distance related information may define a range of the height between two points of the user. For example, when the reference distance related information indicates information on the height, the reference distance related information is information indicating the difference in height between the previous ground height and the current ground height. Additionally, the reference distance related information may be only information of the height or may be included together with information indicating the difference between the longitude and latitude or the distance difference.

The reference distance related information may be stored in the position related information storage unit 372 not for each user but for all users or for each attribute of the user.

For example, the attributes of the user include the user's nationality, address or residence, or the frequency of logging in to the electronic commerce service or the frequency of performing an action.

In this case, for example, the distance difference in the reference distance related information may be changed depending on the nationality or address of the user, or the distance difference may be increased when the log-in frequency or the execution frequency of the action is high.

### (Position Difference Information)

The position difference information of the present embodiment has, for example, a difference between two points of longitude and latitude or a distance difference, as in the case of the reference distance related information.

The position difference information of the present embodiment is information of a position difference calculated by each terminal device 20 of the user and is provided from each terminal device 20 to the authentication server 30 via the service management server 10 or directly at an action execution timing or an action execution related timing when a network service is provided.

For example, the position difference information is a difference in latitude and longitude, a difference in distance, a difference in height, or a difference in both based on the current location of the terminal device 20 at the last action execution timing (i.e., immediately preceding) when the network service is provided and at the current action execution timing when the network service is provided. Additionally, the previous action execution timing may be the action execution timing before the previous action execution timing or may be the action execution timing before the previous action execution timing, and may be the timing in the past.

The position difference information of the present embodiment is specified by each terminal device 20 using a GPS signal or the like and is basically provided from each terminal device 20 to the authentication server 30.

The position difference information is provided to the authentication server 30 via the service management server 10. Note that the position difference information may be directly provided from each terminal device 20 to the authentication server 30.

In the case where the longitude and latitude are used, or an area or a country is long from the east to west or north to south, the latitude and longitude may be either one of the latitude and longitude as long as one of the latitude and longitude can be limited.

The position difference information is stored in the position related information storage unit 372 in association with the user identification information (UID) for each user, as in the case of the reference distance related information.

Specifically, when the position difference information of each user is acquired at each action execution timing or at each action execution related timing while the network service is provided, and when new position difference information is registered, the position difference information registered in the past is stored in the position related information storage unit 372 as recorded information.

The action execution related timing includes, for example, an arbitrary timing designated by the user, a random timing, a timing before the action execution timing arrives, and a timing that arrives at each predetermined period (every day or every week, etc.).

### [A4-3] Management of Reference Distance Related Information and Position Difference Information

Next, the process executed by the authentication server 30 of the present embodiment, which is the management of the location information of the supplier and the client, will be described.

The position information management unit 302: works with the service management server 10; acquires, for each user at a given timing such as when the user is registered in the network service, the reference distance related information which serves as a reference for determining the authenticity of a user who has instructed a given action for a network service; and registers the reference distance related information in the position related information storage unit 372.

When the position difference information of the specific user is acquired at the action execution timing, the action execution related timing, or at each action execution related timing, the position information management unit 302 registers the acquired position difference information in the position related information storage unit 372 in association with each user.

Specifically, the position information management unit 302 registers the position difference information acquired by the identification process of each specific user in the position related information storage unit 372 at the action execution timing.

When new position difference information is registered, the position information management unit 302 updates the position difference information registered in the past as recorded information.

When the position difference information of a specific user is acquired at each action execution related timing such as an arbitrary timing designated by the user, a random timing, a timing before the arrival of the action execution timing, or a timing that arrives at each predetermined period, the position information management unit 302 registers the acquired position difference information in the position related information storage unit 372 as recorded information in association with each user.

For example, the timing that comes at each predetermined period includes a timing requested by the electronic commerce service provider (for example, once or a timing of using the electronic commerce service), a specific timing such as once a day or once a week, or a timing of logging in the electronic commerce service.

### [A4-4] Identification Process

Next, the process executed by the authentication server 30 of the present embodiment, which is the identification process to execute the electronic commerce, will be described.

The position information management unit 302 works with the service management server 10 and executes the identification process of identifying the specific user (including the user who is assumed to become the specific user in the future). when executing the authentication process or the authentication determination process.

Specifically, the position information management unit 302 identifies the user based on the user ID that has logged in the network service.

The position information management unit 302 receives user identification information (e.g., UID) of the user transmitted from the service management server 10 via the communication control unit 301.

The position information management unit 302 searches the position related information storage unit 372 based on the received position related information of the user (hereinafter referred to as “received user identification information”).

When detecting the user identification information that matches the received user identification information and that is stored in the position related information storage unit 372, the position information management unit 302 identifies the user having the detected user identification information as the specific user.

For example, the user information is information such as a user ID or the user ID and a user password registered in advance.

### [A4-5] Authentication Determination Process

Next, the authentication determination process executed by the authentication server 30 of the present embodiment will be described.

### (Outline of Authentication Determination Process)

The determination processing unit 303 determines whether the specific user who has instructed the action is authentic at the action execution timing when the action for the network service is executed.

The determination processing unit 303 determines whether the user (including an organization such as a company) who lives in the real world is the authorized party, and who is not a member of any Antisocial Forces, as the authenticity of the specific user.

Specifically, the determination processing unit 303 performs as the authentication determination process:
(A1) a position information acquisition process of acquiring position difference information indicating a difference between the current position of the specific user and the position of the specific user at a past timing at an action execution timing or an action execution related timing; and
(A2) a condition determination process of comparing the acquired position difference information with reference distance related information of the user who becomes the specific user and determining whether the result of the comparison satisfies a given user condition.

The determination processing unit 303 determines the authenticity of the specific user based on the determination result of the executed condition determination process.

### (Position Information Acquisition Process)

The determination processing unit 303 acquires, from the service management server 10, position difference information of the specific user at the action execution timing when the action for the network service is executed in the terminal device 20 of the specific user.

Specifically, the determination processing unit 303 acquires, as position difference information, a difference in latitude and longitude or a difference in distance based on the current position of the action execution timing of the last (i.e., immediately preceding) action for the network service and the action execution timing of the current action for the network service for the specific user from the service management server 10.

The determination processing unit 303 may directly acquire the position difference information from the terminal device 20 to which the specific user corresponds.

The determination processing unit 303 may acquire, as the position difference information, a difference between the previous action execution timing and the current action execution timing, such as the previous time (the time before the previous time) or the time before the previous time, instead of the difference between the previous action execution timing and the current action execution timing in the position difference information.

Every time the position difference information of each user is acquired, the determination processing unit 303 registers the position difference information in the position related information storage unit 372 in association with the already registered position difference information and updates the already registered position difference information as recorded information.

### (Condition Determination Process)

As the condition determination process, the determination processing unit 303 compares the position difference information of the specific user acquired at the action execution timing when a given action for the network service is executed with the reference distance related information registered in association with the user who becomes the specific user, and determines whether the result of the comparison satisfies the given user condition.

Specifically, the determination processing unit 303 uses, as the user condition, for example, a condition that the distance indicated by the position difference information of the specific user is within the distance range (for example, within 10 km) defined in the reference distance-related information.

In the authentication determination process, the determination processing unit 303 determines that the specific user is the authorized party when the user condition is satisfied and determines that the specific user is not the authorized party when the user condition is not satisfied.

On the other hand, when the position difference information of the specific user is registered in the position related information storage unit 372 at each predetermined timing, the determination processing unit 303 may execute the condition determination process based on the recorded information of the specific user.

In this case, the determination processing unit 303 executes the condition determination process on the basis of: the position difference information indicated by the position difference information of the specific user acquired at the action execution timing; the recorded information (position difference information) of the relevant specific user already registered in the position related information storage unit 372, and the reference distance related information registered as the user of the specific user.

In other words, in this case, since the active position of the specific user can be continuously recognized at the time of executing the network service, the authenticity of the specific user can be determined by using the difference between the present position and the past position while taking into consideration the acquisition of the personal information.

Specifically, in this case, the determination processing unit 303 compares each piece of the position difference information of the corresponding user stored as recorded information of the specific user with reference distance related information registered in association with the user who becomes the specific user, and determines whether all comparison results satisfy a given user condition.

The determination processing unit 303 uses, as the user condition, for example, a condition that the position difference indicated by the position difference information of the specific user is within the distance range of the reference distance-related information registered as the specific user.

In the case where the reference distance related information is stored for each attribute of the user, the determination processing unit 303 may specify the attribute of the transaction source based on the already registered attribute and acquire the reference distance related information based on the specified attribute when executing the condition determination process.

For example, the already registered attribute indicates an attribute specified based on information input by each user at a given timing such as when the user is registered in a commerce service.

### [A4-6] Authentication Process

Next, the authentication determination process executed by the authentication server 30 of the present embodiment will be described.

At the action execution timing when a given action of the network service is executed, when the authentication determination process determines that the specific user is the authorized party, the authentication processing unit 304 executes authentication process of authenticating the execution of the corresponding action.

Specifically, the authentication processing unit 304 authenticates the execution of the corresponding action when the specific user is determined to be the authorized party by the authentication determination process, and rejects the execution of the corresponding action without authentication the execution when the specific user is determined not to be the authorized party.

When determining that the specific user is the authorized party, the authentication processing unit 304 may authenticate the execution of the corresponding action on the assumption that the identification of the specific user has been confirmed. When determining that the specific user is not the authorized party, the authentication processing unit 304 may reject the execution of the corresponding action without authentication the execution on the assumption that the identification of the specific user cannot be confirmed. In this case, the authentication process may be used together with another authentication process of identifying the person, such as face image authentication, two step authentication, or one time password, in order to increase the accuracy of the authentication process.

### [A4-7] Providing Process

Next, the providing process of providing the result of the authentication process executed by the authentication server 30 of the present embodiment to the service management server 10 will be described.

When the authentication is rejected by the authentication process, the information providing unit 311 provides the service management server 10 with result information indicating the result of the authentication rejection by the authentication process.

At this time, the service management server 10 notifies the result information that the authentication of the corresponding terminal device 20 has failed, and ends the process relating to the action on the assumption that the execution of the action has not been established.

When the authentication process succeeds in the authentication, the information providing unit 311 provides the service management server 10 with result information indicating the result of the successful authentication.

At this time, the service management server 10 notifies the result information that the authentication of the corresponding terminal device 20 has succeeded, and controls the execution of the corresponding action.

Further, the information providing unit 311 may provide the result information of the authentication process to the terminal device 20 of the corresponding user directly or via the service management server 10.

When the authentication is successful by the authentication process, the information providing unit 311 provide the service management server 10 with the information on the assumption that the identification of the specific user has been confirmed. In this case, when the authentication is rejected by the authentication process, the information providing unit 311 provides the service management server 10 with the information on the assumption that the identification of the specific user cannot be confirmed.

### [A5] Operation of the Present Embodiment

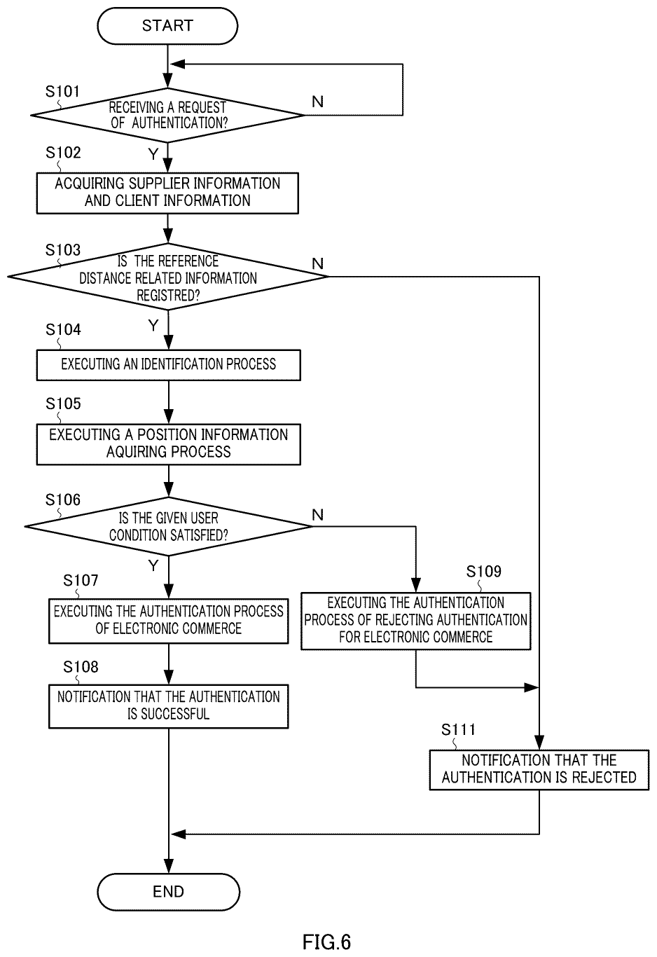

Next, the operation relating to the authentication process executed by the authentication server 30 of the present embodiment will be described with reference to FIG. 6.

FIG. 6 is a flowchart illustrating the operation of the authentication process executed by the authentication server 30 of the present embodiment.

In the operation, it is assumed that reference distance related information, which is defined as information of reference distances of a plurality of users or as information related to the distances, is registered in advance.

In the operation, it is assumed that the service management server 10 executes each process related to the network service with the corresponding terminal device 20, and that identification information and current position information have been obtained already.

First, when receiving an authentication request for a given action for the network service from the service management server 10 (step S101), the position information management unit 302 acquires user identification information for identifying a specific user as user information from the service management server 10 (step S102).

Next, the position information management unit 302 searches for the position related information storage unit 372 based on the acquired user identification information, and determines whether the reference distance related information based on the user identification information is stored in the position related information storage unit 372 (step S103).

At this time, when determining that the reference distance related information is stored in the position related information storage unit 372 in association with the acquired user identification information, the position information management unit 302 proceeds to the process of the step S104.

When it is determined that the reference distance related information is not stored in the position related information storage unit 372 in association with any of the acquired user identification information, the information providing unit 311 transmits a notification to the service management server 10 that the authentication of the execution of the given action for the network service is refused (step S111), and terminates the operation.

Next, when determining that the reference distance related information is stored in the position related information storage unit 372 in association with the acquired user identification information, the position information management unit 302 executes an identification process of specifying the user corresponding to the user identification information as a specific user who executes the action for the network service (step S104).

Next, the determination processing unit 303 executes a position information acquisition process of acquiring position difference information indicating a position difference when a given action is executed for the network service of the specified user specified from the service management server 10 (step S105).

Next, the determination processing unit 303 compares the acquired position difference information of the specific user with the reference distance related information, and executes authentication determination process of determining whether the result of the comparison satisfies a given user condition (step S106).

At this time, when determining that the comparison result satisfies the given user condition, the determination processing unit 303 proceeds to the process of the step S107, and when determining that the comparison result does not satisfy the given user condition, the user information management control unit 103 proceeds to the process of step S109.

Next, when determining that the specific user is the authorized party by the authentication determination process, the authentication processing unit 304 executes authentication process of authenticating execution of a given action for the corresponding network service (step S107).

Next, the information providing unit 311 transmits a notification indicating that the execution of the corresponding action is authenticated (the authentication is successful) to the service management server 10 (step S108), and terminates this operation.

On the other hand, when it is determined that the specific user is not authentic, the authentication processing unit 304 executes an authentication process of rejecting the authentication without authentication for the execution of the corresponding action (step S109).

Next, the information providing unit 311 transmits a notification indicating that the authentication of the corresponding action has not succeeded to the service management server 10 (step S111), and terminates this operation.

### [A6] Modification

### [A6-1] First Modification

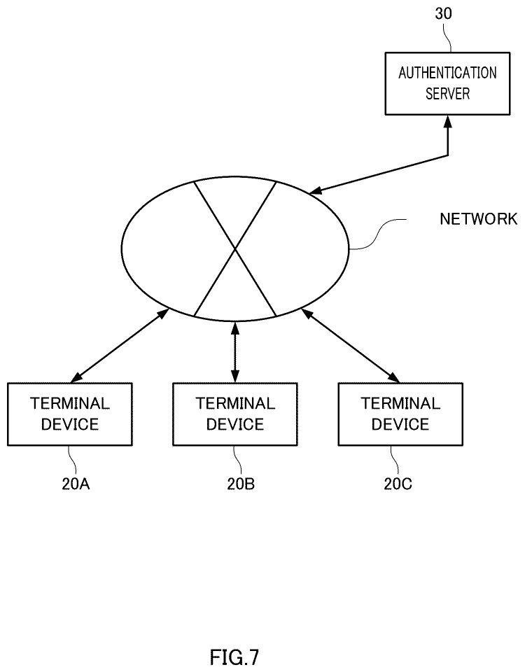

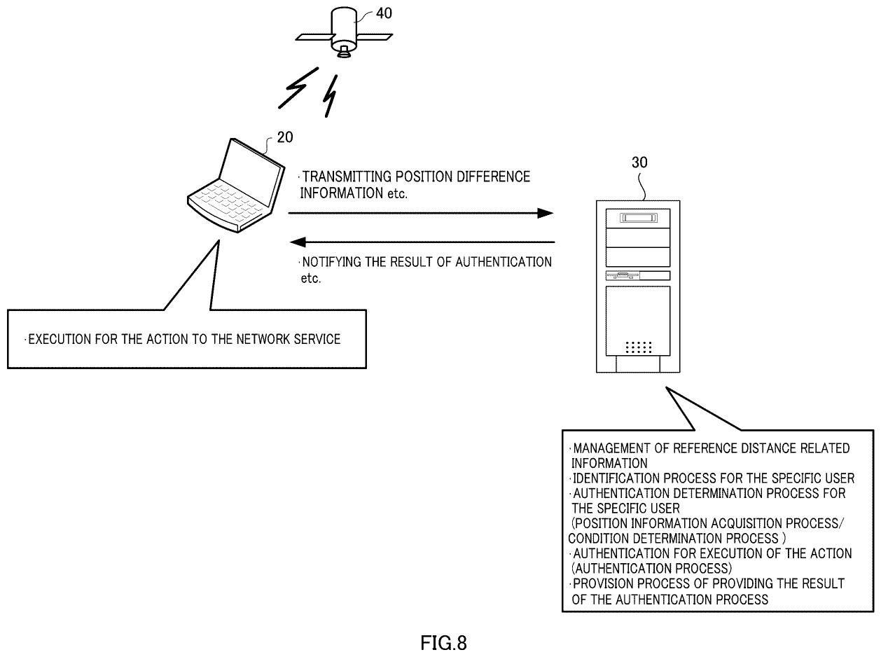

Next, a case where the execution of the above actions is executed on the terminal device 20 such as an application will be described as a first modification of the above embodiment with reference to FIGS. 7 and 8.

FIG. 7 is a system configuration diagram illustrating a network service provision system S2 of the present modification, and FIG. 8 is a diagram for explaining the authentication process executed by the authentication server 30 when a given action is executed on the terminal device 20 in the present modification.

The network service provision system S2 of the present modification is a system for allowing a user to use the network service by using a given application registered in the terminal device 20, as illustrated in FIGS. 7 and 8.

Specifically, the network service provision system S2 of the present modification is an effective system for preventing a specific user from impersonating a legitimate user and executing the network service using the terminal device 20.

As illustrated in FIG. 7, the network service provision system S2 of the present modification is configured by the terminal devices 20 (for example, terminal devices 20A, 20B, and 20C) that directly executes a network service with another terminal device 20, and the authentication server 30 that executes each process of authenticating the network service.

Specifically, the terminal device 20 uses a network service by using an application, for example, and executes an action for the network service (i.e., an action in the case where a process on the network is executed by the application).

When instructing execution of the action for the network service, the terminal device 20 transmits position difference information as the specific user to the authentication server 30, and controls execution of the action when the terminal device 20 is authenticated as the specific user.

At this time, the authentication server 30 has a configuration for managing distance reference information of a user, which is information registered in advance.

The authentication server 30 is configured to specify the specific user who instructs execution of an action for the network service based on user information of the terminal device 20 that indicates the specific user transmitted from the terminal device 20 that executes the network service.

As illustrated in FIG. 8, the authentication server 30 is configured: to execute:
(A1) the authentication determination process of determining authenticity of the specific user when a given action is executed for the network service;
(A2) the authentication process of authenticating the network service based on a result of the authentication determination process at the timing of execution of the action; and
(A3) providing process of providing the result of the authentication process to the terminal device 20 of the specific user.

Specifically, the authentication server 30 executes the authentication determining process as in the above embodiment, as the authentication determining process:
(A2-1) a position information acquisition process of acquiring at a timing corresponding to an action execution timing or an action execution related timing related to the action execution timing, position difference information indicating a difference between a current position of a specific user and a position of the specific user at a past timing; and
(A2-2) condition determination process of comparing the acquired position difference information with reference distance related information of the user who becomes the specific user, and determining whether the result of the comparison satisfies a given user condition. The authentication server 30 executes the authentication determining process based on the result of the determination of the executed condition determination process.

FIG. 8 shows an example of the terminal device 20 that: acquires the position difference information specified from position information based on the GPS signal transmitted from the GPS satellite 40; transmits the acquired position difference information to the authentication server 30; and receives the result of the authentication process, while executing a given action for the network service.

Further, FIG. 8 shows an example of an authentication server 30 that: executes the management of reference distance related information; the identification process of the specific user, acquisition of position difference information based on the current position of the terminal device 20; the authentication determining process (position information acquisition processing and condition determination process); authentication process of authentication execution of an action; and provision process of providing a result of the authentication process.

### [A6-2] Second Modification

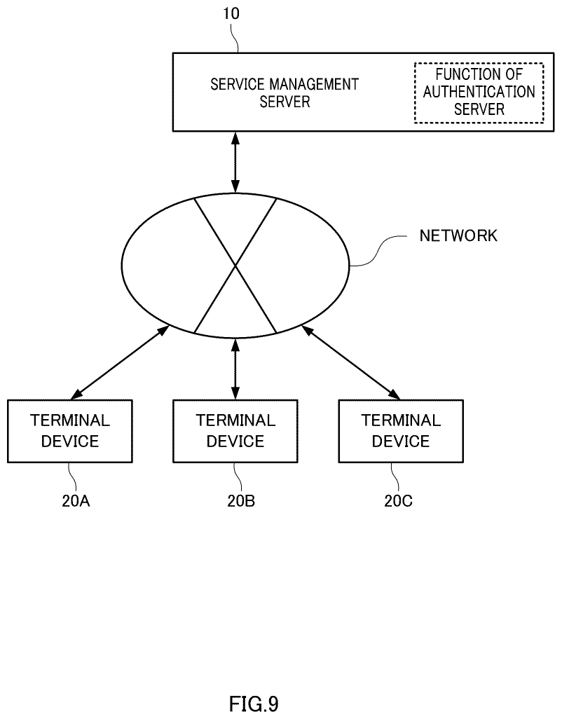

Next, a case where the service management server 10 has the respective functions of the authentication server 30 in the above embodiment will be described as a second modification of the present embodiment with reference to FIG. 9.

FIG. 9 is a system configuration diagram illustrating the network service provision system S3 according to the present modification.

The service management server 10 of the present modification has a configuration for executing authentication determination process of determining the authenticity of a specific user and authentication process of authenticating the network service when a given action for the network service is executed by the specific user using user-related information relating to the managed user.

Specifically, the service management server 10 is configured to manage reference distance related information of the specific user, which is information registered in advance.

As illustrated in FIG. 9, the service management server 10 is configured to execute:
(A1) the authentication determination process of determining whether the specific user satisfies a given user condition when a given action is executed for the network service;
(A2) the authentication process of authenticating the network service based on a result of the authentication determination process at the timing of execution of the action; and
(A3) providing process of providing the result of the authentication process to the terminal device 20 of the specific user.

Specifically, the service management server 10 executes the authentication determining process as in the above embodiment, as the authentication determining process:
(A2-1) a position information acquisition process of acquiring, at a timing corresponding to an action execution timing or an action execution related timing related to the action execution timing, position difference information indicating a difference between a current position of a specific user and the position of the specific user at a past timing; and
(A2-2) a condition determination process of comparing the acquired position difference information with reference distance related information of the user who becomes the specific user, and determining whether the result of the comparison satisfies a given user condition. The authentication server 30 executes the authentication determining process based on the result of the determination of the executed condition determination process.

### [A6-3] Third Modification

Next, a third modification of the above embodiment will be described in which the authenticity of a specific user is determined in advance before a given action is executed for a network service, and an authentication process of authenticating the execution of the action is executed based on the result of the determination.

### (Characteristics of Present Modification)

The present modification is characterized in that, the authentication determination process is executed at the timing related to the execution of the action such as before or after the execution of the action, and the execution of the action is executed as the authentication process based on the result of the authentication determining, instead of executing the authentication determination process and the authentication process based on the position difference information of the specific user when a given action is executed for the network service in the above embodiment.

The authentication server 30 of the present modification has a configuration for determining the authenticity of a user who can be the specific user before executing the action based on the position difference information of the user acquired at a given timing or at each predetermined timing.

Specifically, the authentication server 30:
(A1) executes the position information acquisition process of acquiring position difference information indicating a difference between the current position of the specific user and a position of the specific user at a past timing, at each timing corresponding to a predetermined timing, as an action execution related timing;
(A2) registers the acquired position difference information in the position related information storage unit 372 as recorded information of the corresponding user; and
(A3) executes the authentication determination process of comparing the recorded information of the specific user with the registered reference distance related information of the user as the specific user, and determine whether the comparison result satisfies the user condition, before or after a given action is executed for the network service.

Specifically, the recitation “before the action is executed” includes a timing when the user logs in the network service (i.e., the service management server 10), a timing when the user executes a predetermined action such as data saving, a predetermined timing (a predetermined time such as 0:00 every day), or the like. Note that the timing is not limited to the timing before the execution timing of the action.

The authentication server 30 holds the result of the authentication determination process, and executes the authentication process based on the result of the authentication determination process when the action is executed.

On the other hand, the recitation “after the action is executed” indicates, for example, the timing of the confirmation of the content of the comment or the timing of the reflection of the content of the comment in the Web service in the case where the content of the comment is confirmed and posted in a given Web service and the posted comment is reflected in the Web service after the confirmation of the content of the comment.

### [A6-4] Fourth Modification

Next, as a fourth modification of the above embodiment, a case where the position difference information of the user is acquired in the above embodiment or the above modifications, the time when the position difference information is acquired is specified, and the time information indicating the time is used for the authentication determination process will be described.

The authentication server 30 of the present modification has a configuration for: acquiring the position difference information of the user at each action execution timing, the action execution related timing, or at each action execution related timing; and specifying the time when the position difference information is acquired.

The authentication server 30 of the present modification has a configuration for executing authentication determination process based on each piece of position difference information including time information indicating the specified time.

Specifically, when the authentication determination process of the specific user is executed using the time information of the position difference information, the determination processing unit 303 determines whether the moving speed or acceleration of the user as the specific user is consistent.

For example, the determination processing unit 303 calculates the moving speed or acceleration of the specific user based on the time information associated with the previous position difference information, the time information associated with the position difference information acquired this time, and the distance between the two points of the previous and current position difference information.

The determination processing unit 303: determines whether or not the calculated moving speed or acceleration is within a predetermined range on the user condition that the comparison result between the position difference information and the reference distance related information of the above embodiment; and determines that the specific user is the authorized party when the calculated moving speed or acceleration is within the predetermined range.

Specifically, the determination processing unit 303 determines whether the calculated moving speed or acceleration is equal to or less than a reference moving speed or acceleration (i.e., reference speed or reference acceleration) associated with the reference distance related information.

The determination processing unit 303 determines that the specific user is the authorized party when the calculated moving speed or acceleration is equal to or less than the reference moving speed or reference acceleration.

The time information of the present modification indicates information of a term when the distance difference of the position difference information occurs (hereinafter, referred to as “position difference period”), instead of the time information of the time when the position difference information is acquired.

The information may be the information of the position difference period from the time information associated with the previous position difference information to the time information associated with the position difference information acquired this time.

In this case, the position difference period is also used when calculating the moving speed or acceleration of the transaction target person, as described above.

### [A6-5] Fifth Modification

Next, a description will be given of a case where the network service is executed based on the result of the authentication determination process without executing the authentication process in the fifth modification of the above embodiment.

The authentication server 30 of the present modification has a configuration in which, when it is determined that the specific user is the authorized party, the result is provided to the service management server 10 or the terminal device 20 that executes a given action for the network service.

Specifically, the authentication server 30 is configured to manage reference distance related information of the specific user, which is information registered in advance.

The authentication server 30 is configured to specify a specific user who is to be executed an action for the network service based on user information of the terminal device 20 which is to be the specific user and transmitted from the service management server 10 or the terminal device 20 which executes the network service.

The authentication server 30 is configured: to execute:
(A1) the authentication determination process of determining authenticity of the specific user when an action is executed; and
(A2) the provision process of providing the determination result of the authentication determination process to the service management server 10 or the terminal device 20 at the action execution timing.

Specifically, the authentication server 30 executes the authentication determining process as in the above embodiment, as the authentication determining process:
(A2-1) a position information acquisition process of acquiring, at a timing corresponding to an action execution timing or an action execution related timing, position difference information indicating a difference between the current position of a specific user and the position of the specific user at a past timing; and
(A2-2) a condition determination process of comparing the acquired position difference information with reference distance related information of the user who becomes the specific user, and determining whether the result of the comparison satisfies a given user condition. The authentication server 30 executes the authentication determining process based on the result of the determination of the executed condition determination process.

### [A6-6] Sixth Modification 6

Next, as a sixth modification of the above embodiment, a case where the authentication process of the network service is used for login process in the above embodiment or modification will be described.

The authentication server 30 of the present modification has a configuration for executing the authentication process of authenticating a login of the specific user to the network service based on a result of the authentication determination process at a timing when the user logs in to the network service as the action execution related timing.

Specifically, the authentication server 30 of the present modification is configured to:
(A1) acquire, at a timing at which the specific user logged in to the network service, as the position information acquisition process, the position difference information indicating a difference between a current position of the specific user and a position of the specific user at a past timing (for example, a timing at which the specific user logged in to the network service in the past), and
(A2) execute the authentication determination process of comparing the acquired position difference information with the registered reference distance related information of the specific user when the login is executed, and determining whether the comparison result satisfies the user condition.

The authentication server 30 of the present modification may execute the authentication determination process at a timing related to the execution of login, such as before the user logs in to the network service.

In this case, the authentication server 30 of the present modification may acquire the position difference information at another timing, such as a timing when the user is not logged in to the network service.

### [A6-7] Seventh Modification

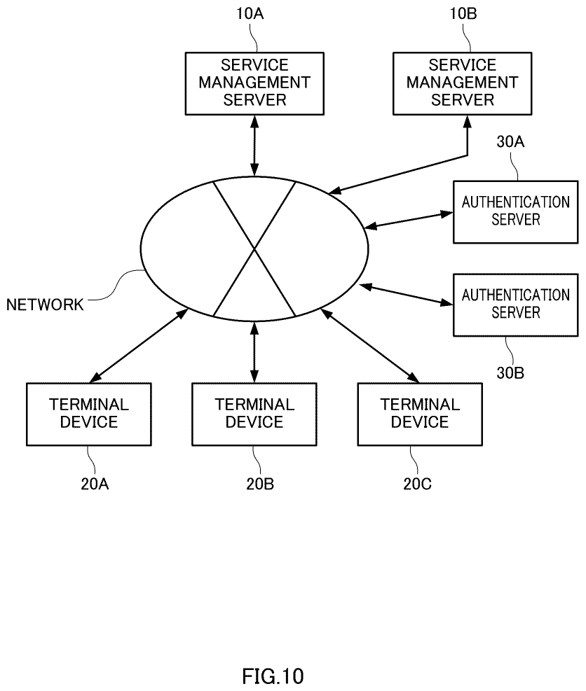

Next, a network service provision system S4 configured by a plurality of servers according to a seventh modification of the above embodiment will be described with reference to FIG. 10.

FIG. 10 is a system configuration diagram illustrating the network service providing system according to the seventh modification of the present embodiment.

In the above embodiment or the above modifications, the network service provision system S3 may be configured by a plurality of service management servers 10 or a plurality of authentication servers 30.

When the network service provision system S4 is configured by the plurality of service management servers 10, the network service provision system S4 includes the terminal devices 20 of the specific user and the service management servers 10A and 10B for executing the processing relating to the specific user, as illustrated in FIG. 10.

The service management server 10A and the service management server 10B establish a communication line through the network N and perform various processes in conjunction with each other to perform various processes related to the networks service.

When the network service provision system S3 is configured by a plurality of authentication servers 30, the network service provision system S3 includes, as illustrated in FIG. 10, the authentication servers 30A and 30B that execute the authentication process of the specific user in conjunction with the service management servers 10A and 10B that execute process of the specific user.

### [B] Second Embodiment

### [B1] Outline of Electronic Commerce System

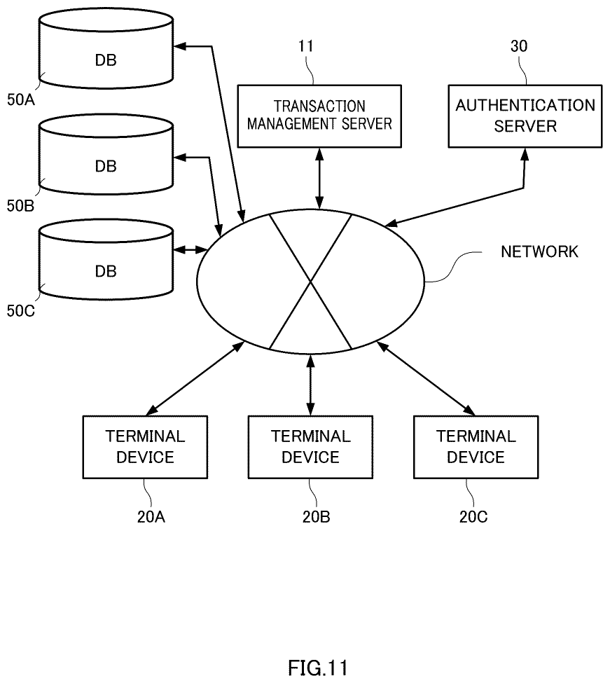

First, the outline and the system configuration of an electronic commerce system S in the present embodiment will be described with reference FIG. 11.

FIG. 11 is a system configuration diagram illustrating an embodiment of an electronic commerce system S11.

In order to prevent the drawings from becoming complicated, only some terminal devices 20 used by users and only some databases 50 are shown in FIG. 11. In other words, the electronic commerce system S11 has more terminal devices 20 and more databases 50 than shown on FIG. 11.

The embodiment described below is an embodiment in which the electronic commerce authentication system, the electronic commerce management system, and the like of the present application are applied to an electronic commerce system using a network that has a commerce transaction management server for managing electronic commerce, a terminal device used by a user who performs electronic commerce, and an authentication server for authenticating the electronic commerce, and registers information on electronic commerce in a plurality of databases in a distributed manner.

The electronic commerce indicates conducting commercial transactions such as the sale of products or services, exchanging crypto-assets as consideration for products or services, or exchanging crypto-assets for legal tender as consideration for the acquisition of crypto-assets (i.e., a commercial transaction to sell or buy crypto-assets themselves) by electronic means on a network or computer.

### (Outline of the System)

As illustrated in FIG. 11, the electronic commerce system S of the present embodiment is a system for realizing commercial transactions such as a sale of products or a service by electronic means on a network or a computer using crypto-assets.

The electronic commerce system S11 has a configuration for realizing commercial transactions between a user (i.e., a supplier) who performs a transaction to propose the provision or transaction of a transaction object such as a product in the electronic commerce, and a user (i.e., a client) who performs a transaction to obtain the proposed transaction object in exchange for payment of a price in the electronic commerce.

Specifically, the electronic commerce system S11 of the present embodiment is configured to be able to realize fair, genuine, and highly reliable transactions in electronic commerce using a cryptographic asset in order to reliably specify the cash flow when electronic commerce using a cryptographic asset is executed or the history (tracking) of a product that has been the subject of the electronic commerce, based on the result of a determination as to whether the transaction source and the transaction partner are appropriate as transaction subjects, and therefore to be able to realize fair, genuine, and highly reliable transactions in electronic commerce using a cryptographic asset.

### (System Configuration)

As illustrated in FIG. 11, the electronic commerce system S11 of the present embodiment has: an transaction management server 11 to execute various processes for managing electronic commerce; terminal device 20 (for example, terminal devices 20A, 20B, and 20C) connected to the transaction management server 11 through a network such as the Internet and used by a user who performs electronic commerce; and an authentication server 30 to execute various processes for authenticating electronic commerce in conjunction with the transaction management server 11.

The transaction management server 11 is an information processing device that executes various processes related to the electronic commerce using, for example, an API (application programming interface) or a predetermined platform.

Specifically, the transaction management server 11 has an exchange function for executing the electronic commerce, and also has a function as a custodial wallet for managing information (e.g., a secret key) for authenticating the user on behalf of the user when a money transfer is executed between users.

The transaction management server 11 may be configured by one device (or processor) or a plurality of devices (or processors).

Specifically, the transaction management server 11 is configured; to manage the electronic commerce between the supplier and the customer, and when the electronic commerce is approved by the authentication server 30, and to resister the electronic commerce information in a database (hereinafter, also referred to as “DB”) 50.

The transaction management server 11 is configured to register the electronic commerce information in a plurality of databases 50 using a distributed ledger technology such as a blockchain which is difficult to be falsified.

In particular, the transaction management server 11 configured: to generate block information by blocking the electronic commerce information based on a plurality of electronic commerce information and a hash value determined from past electronic commerce information; and to register the block information in each database 50.

The terminal device 20 is a communication terminal device that serves as an information processing device used by users such as a PC (personal computer), a tablet-type information communication terminal device, a smart phone, a mobile phone and an HMD.

The terminal device 20 is connectable to the transaction management server 11 via a network such as the Internet (WAN) or a LAN and has a configuration for establishing a communication line with the transaction management server 11 by wire or wireless to transmit and receive various data.

The terminal device 20 has a communication control function for communicating input information input by the user with the transaction management server 11, a function for acquiring the current location of the user, and a display function for performing display control using data received from the transaction management server 11.

The authentication server 30 is an information processing device that executes various processes of authenticating the electronic commerce using, for example, an API (application programming interface) or a predetermined platform, as in the case of the transaction management server 11.

The authentication server 30 may be configured by a single device or processor, or a plurality of devices or processors, as in the case of the transaction management server 11.

The authentication server 30 is configured to execute an authentication process for authenticating the electronic commerce by determining the authenticity of the supplier and the customer based on the location information of the supplier and the customer.

The database 50 may be configured by various databases (storage devices and memories in a broad sense) such as a hard disk drive connectable to the network N, or may be added in an information processing device connected to the network N such as a PC (personal computer) or a server.

### [B2] Electronic Commerce Management Server

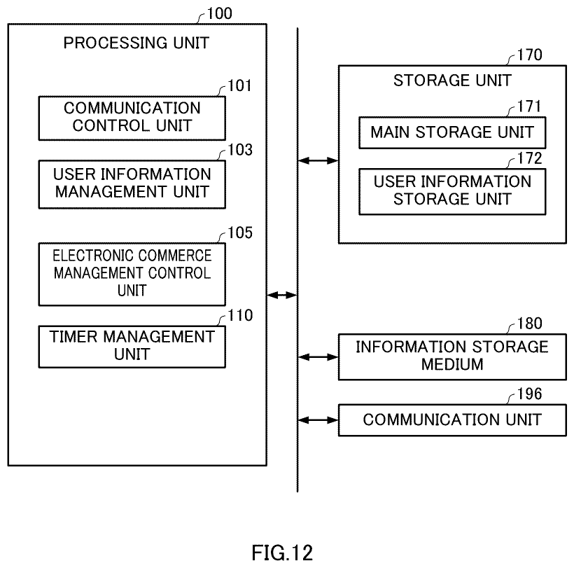

Next, the transaction management server 11 of the present embodiment will be described with reference to FIG. 12.

FIG. 12 is one example of a diagram illustrating functional blocks of the transaction management server 11 of the present embodiment.

As illustrated in FIG. 12, the transaction management server 11 of the present embodiment includes a processing unit 100, a storage unit 170, an information storage medium 180, and a communication unit 196.

The transaction management server 11 of the present embodiment may be configured by omitting one or more composing elements shown in FIG. 12.

The storage unit 170 serves as a work area for the processing unit 100, and the like, and its functions are configured by a RAM (VRAM) or the like.

Specifically, the storage unit 170 includes a main storage unit 171 used for a work area used when various processes are executed, and a user information storage unit 172 storing user information.

The storage unit 170 of the present embodiment may be configured such that a part of the configuration of the main storage unit 171 and the user information storage unit 172 is omitted.

The information storage medium 180 is readable by a computer, and programs, data, and the like are stored in the information storage medium 180. In other words, the information storage medium 180 stores programs for causing the computer to function as the respective units of the present embodiment (programs for causing the computer to execute the processing of the respective units).

The processing unit 100 can perform the various processes of the present embodiment based on data read-out from programs (data) stored in the information storage medium 180.

For example, the information storage medium 180 is an optical disk (CD, DVD), a magneto-optical disk (MO), a magnetic disk, a hard disk, a flash memory such as a solid-state drive, a magnetic tape, a memory (ROM), or a memory card.

The communication unit 196 performs various controls to communicate with an external device (for example, the terminal device 20 or the authentication server 30). The functions of the communication unit 196 is configured by hardware of various processors or ASICs for communication, program and so on.

The processing unit 100 performs the various processes of the present embodiment based on programs (data) stored in the storage unit 370.

The processing unit 100 of the present embodiment may read out the program and data stored in the information storage medium 180, temporarily store the read-out program and data in the storage unit 170, and perform processing based on the program and data.

The processing unit 100 executes various processes using the main storage unit 171 in the storage unit 170 as a work area. The processing unit 100 is implemented by hardware such as various processors (CPU, DSP, etc.), and programs.

Specifically, the processing unit 100 includes a communication control unit 101, an electronic commerce management control unit 105, a user information management control unit 103, and a timer management unit 110.

The communication control unit 101 establishes communication lines with the terminal device 20 and the authentication server 30 through the network and performs communication with each other.

The electronic commerce management control unit 105 works the terminal devices 20 of the users of the customer and the supplier, and executes a process for managing the transaction.

The electronic commerce management control unit 105 manages the transaction object, such as products sold by the supplier, and executes the processes related to transactions with the customer who desires to purchase the products, and various processes for executing the payment of the consideration when the transactions are successful.

Specifically, the electronic commerce management control unit 105: works with the authentication server 30. When the electronic commerce such as a transaction of the sale of a product is executed, for example, the service providing management control unit 102 receives the result of the authentication process of the electronic commerce in the authentication server 30. The service providing management control unit 102 executes each process after the transaction is successful or each process after the transaction is unsuccessful on the basis of the received result.

The user information management control unit 103 manages information of each user as a supplier or a customer.

Specifically, the user information management control unit 103 manages, for example, registration and update of information required for selling a transaction object such as a product and information required for purchasing the transaction object in the user information storage unit 172.

The timer management unit 110 has a function of performing measurement from the current date and time or a predetermined timing, and outputs the current time or a measurement result when the predetermined timing is detected.

### [B3] Authentication Server

Next, the configuration according to the authentication server 30 of the present embodiment will be described.

The authentication server 30 of the present embodiment includes a processing unit 300, a storage unit 370, an information storage medium 380, and a communication unit 396, as in the first embodiment.

Specifically, the processing unit 300 includes the communication control unit 301, the position information management unit 302, the determination processing unit 303, and an authentication processing unit 304, the timer management unit 310, and the information providing unit 311, as in the first embodiment.

The authentication server 30 of the present embodiment may be configured by omitting one or more composing elements, as in the first embodiment.

### [B4] Method of the Present Embodiment

### [B4-1] Outline

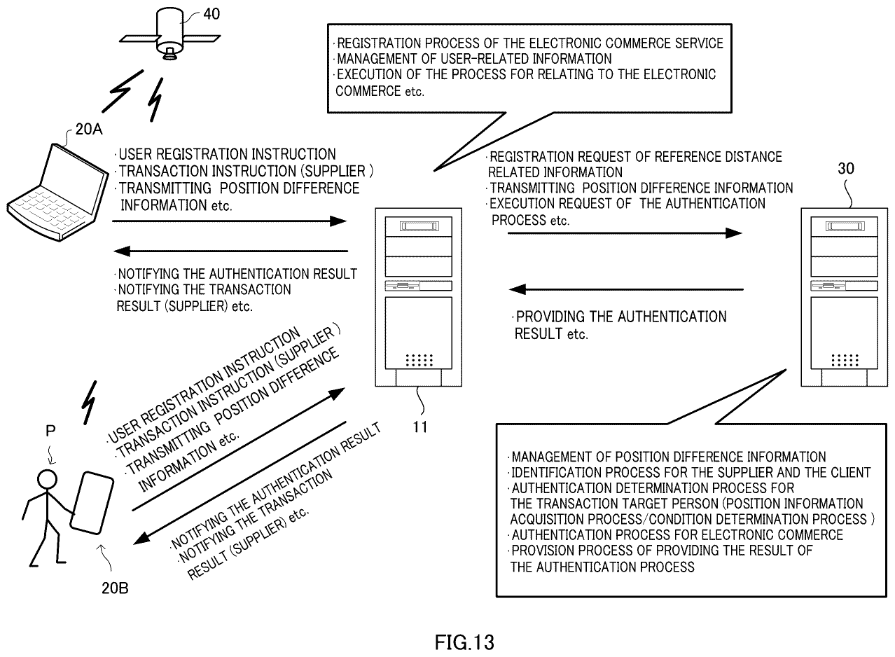

Next, the authentication process and the authentication determination process which are executed by the authentication server 30 of the present embodiment when the electronic commerce is executed, and will be described with reference to FIG. 13, the authentication determination process serving as the criteria for the authentication process.

FIG. 13 is a diagram for explaining the authentication process and the authentication determination process as a determination criterion of the authentication process executed by the authentication server 30 according to the present embodiment when the electronic commerce is executed.

The authentication server 30 of the present embodiment is configured: to determine whether or not at least one of a supplier and a customer of the electronic commerce is the authorized party (in other words, the true and correct party) at the transaction execution timing when the electronic commerce is executed by the transaction management server 11 or at the transaction execution related timing; and to execute the authentication process of authenticating the electronic commerce is valid based on the result of the determination.

In other words, the authentication server 30 of the present embodiment is a device for authenticating a given electronic commerce based on a crypto-asset such as Bitcoin or Ethereum when the supplier and the client execute the electronic commerce based on the position of the supplier and the client.

On the other hand, the authentication server 30 of the present embodiment has a configuration for determining the authenticity of the supplier and the client by using the difference between the positions of two points of the user acquired at a given timing, not the position of the user itself, in order to restrict the acquisition of personal information such as the position of the user.

In other words, the authentication server 30 of the present embodiment has a configuration that can determine the authenticity of the supplier or the client by using the difference between the current position and the past position, not the position of the transaction target person itself, when executing the authentication process of authentication whether or not the electronic commerce is a legitimate transaction.

Specifically, the authentication server 30 of the present embodiment has a configuration for managing reference distance related information which is registered in advance and serves as a reference for authenticating the execution of an action of a corresponding user, as illustrated in FIG. 13.

More specifically, it is preferable that the reference distance related information is stored for each user who executes a given action of the network service, and is stored in association with each user.

The authentication server 30 identifies a transaction target person based on information (hereinafter referred to as “transaction target person information”) relating to at least one of the supplier and the client.

As illustrated in FIG. 13, the authentication server 30 is configured to: execute the determination process (more specifically, the authentication determination process) for determining whether or not a transaction target person satisfies a given transaction target person condition when an electronic commerce transaction is executed; and to execute an authentication process of authenticating the electronic commerce transaction between the specified supplier and the specified client at a transaction execution timing based on the determination result of the authentication determination process.

As illustrated in FIG. 13, the authentication server 30 has a configuration for providing the result of the authentication process to the transaction management server 11.

The authentication server 30, as illustrated in FIG. 13:
(A1) executing, at the action execution timing or the action execution related timing, a position information acquisition process of acquiring difference information indicating a difference between a current position of the transaction target person at the corresponding timing and a position of the transaction target person at a past timing;
(A2) executing a condition determination process of comparing the acquired difference information with the reference distance related information and determining whether the result of the comparison satisfies a given user condition.

The transaction management server 11 is configured to register information on the authenticated electronic commerce in a distributed manner in a plurality of databases 50 as an electronic commerce information when the electronic commerce is authenticated.

The transaction management server 11 stores as the electronic commerce information such as types of funds or types of products or services, distribution channels including information on past suppliers and clients, past transaction dates or date-times, past transaction volumes, and past transaction amounts.

FIG. 13 shows an example of the terminal devices 20A and 20B that acquire position difference information specified from position information based on a GPS signal transmitted from the GPS satellite 40, transmit the acquired position difference information to the authentication server 30 via the transaction management server 11, transmit a registration instruction to the electronic commerce service, transmit a transaction instruction for the commerce, receive a result of the authentication process, and receive a transaction result of the commerce.

Specifically, FIG. 13 shows an example in which a laptop is used as the terminal device 20A and a smartphone owned by the user P is used as the terminal device 20B.

FIG. 13 shows an example of the transaction management server 11 that executes a process of the registering to the electronic commerce service, a process of managing user-related information used for executing each process relating to electronic commerce, and each process relating to electronic commerce.

FIG. 13 shows an example of the authentication server 30 that executes a registration request for the reference distance related information transmitted from the transaction management server 11, acquisition of the position difference information based on the current position of the terminal device 20, the identification process of the supplier and the client, the authentication determination process (the position information acquisition process and the condition determination process), the authentication process of authenticating execution of an action, and the provision process of providing the result of the authentication process.

In other words, the authentication server 30 of the present embodiment can prevent, in the electronic commerce using a crypto-asset, while taking into consideration the acquisition of personal information:
(B1) disadvantages due to the absence of a central administrator for crypto assets (lack of stability due to value guarantees for fiat currencies, etc.);
(B2) reduction of the credibility risk of business transactions based on non-face-to-face transactions (reduction of the reliability of information such as whether the transaction source and the business partner exist); and
(B3) the occurrence of illegal transactions based on such reduced credit risk (exploitation of assets and funds or their use for money laundering).

The authentication server 30 of the present embodiment is configured to be able to realize a fair, genuine, and highly reliable transaction in electronic commerce using a cryptographic asset while taking into consideration the acquisition of personal information.

In this embodiment, the crypto assets refer to assets of financial value that can be exchanged over a network such as Ethereum, can be used to pay for purchases in commercial transactions, can be exchanged for legal tender, and are electronically recorded and transferable.

For example, Bitcoin and Ethereum are known as typical crypto-assets. Additionally, the “crypto-assets” in this embodiment may include the legal tender (the electronic legal tender) issued in digital form such as “yen”, “dollar”, “euro”, or “yuan”.

### [B4-2] Reference Distance Related Information and Position Difference

Next, the reference distance related information and the position difference information according to the present embodiment will be described.

### (Reference Distance Related Information)

The reference distance related information of the present embodiment is information indicating a positional difference that enables identification of verification as in the first embodiment, but is information in which a distance that serves as a reference for determining the authenticity of each user (supplier and client) of electronic commerce or information related to the distance is defined, and is information indicating a difference in the authenticity of each user when the user moves from a position where the user has existed in the past.

The reference distance related information is stored in the position related information storage unit 372 in association with user identification information (UID) for each user.

The reference distance related information is information that serves as a criterion for determining the authenticity of the use (i.e., the supplier and client) that has instructed the action for the network service, and is information that defines the maximum movement range between two points of the trader that can be determined as the authenticity.

For example, the reference distance related information may be differences in latitude and longitude or distance between two points. In the case of an area or a country that is long from the east to west or north to south, the latitude and longitude may be either one of the latitude and longitude as long as one of the latitude and longitude can be limited.

The reference distance related information is stored in the position related information storage unit 372 for each user identification information under the operation input of the terminal device 20 of each user through service management server 11 when the user newly registers in the network service.

For example, the reference distance related information includes, as in the first embodiment:
(A1) a user ID (UID) used as the user identification information; and
(A2) difference of the longitude and the latitude as the location of activity for reference.

### (Position Difference Information)

The position difference information of the present embodiment has, for example, a difference between two points of longitude and latitude or a distance difference, as in the case of the reference distance related information, as in the first embodiment. The position difference information of the present embodiment is information of a position difference calculated by each terminal device 20 of the user, and is provided from each terminal device 20 to the authentication server 30 through the transaction management server 11 or directly at the transaction execution timing or the transaction execution related timing of the electronic commerce.

For example, the position difference information is a difference in latitude and longitude, a difference in distance, a difference in height, or a difference in both based on the current position of the terminal device 20 at the transaction execution timing of the last (i.e., immediately preceding) electronic commerce transaction and the transaction execution timing of the current electronic commerce transaction. Note that the transaction execution timing of the last electronic commerce may be the transaction execution timing before the last transaction execution timing, or may be the transaction execution timing two times before, and may be the timing in the past.

The position difference information is stored in the position related information storage unit 372 in association with the user identification information (UID) for each user, as in the first embodiment.

Specifically, when the position difference information of each user is acquired at each action execution timing or at each action execution related timing of the electronic commerce, and when new position difference information is registered, the position difference information registered in the past is stored in the position related information storage unit 372 as recorded information.

The transaction execution related timing includes, for example, an arbitrary timing designated by the user, a random timing, a timing before the transaction execution timing arrives, and a timing that arrives at each predetermined period (every day or every week, etc.).

### [B4-3] Management of Reference Distance Related Information and Position Difference Information

Next, the process executed by the authentication server 30 of the present embodiment, which is a process of managing the reference distance related information and the position difference information of the supplier and the client will be described.

The position information management unit 302: works with the transaction management server 11; acquires the reference distance related information which serves as a reference for determining the authenticity of the supplier and the client of an electronic commerce for each user who becomes the supplier or the client at a given timing such as when the user is registered in the electronic commerce service; and registers the reference distance related information in the position related information storage unit 372.

When the position difference information of the transaction target person is acquired at the transaction execution timing, or the transaction execution related timing, or at each transaction execution related timing, the position information management unit 302 registers the acquired position difference information in the position related to the position related information storage unit 372 in association with each user.

Specifically, the position information management unit 302 registers the position difference information acquired by the identification process for each transaction target person in the position related information storage unit 372 at the transaction execution timing.

When new position difference information is registered, the position information management unit 302 updates the position difference information registered in the past as recorded information.

When the position difference information of the transaction target person is acquired for each transaction execution related timing such as an arbitrary timing designated by the user, a random timing, a timing before the arrival of the transaction execution timing, or a timing that arrives at each predetermined period, the position information management unit 302 registers the acquired position difference information in the position related information storage unit 372 as recorded information in association with each user.

For example, the timing that comes at each predetermined period includes a timing requested by the electronic commerce service provider (for example, once or a timing of using the electronic commerce service), a specific timing such as once a day or once a week, or a timing of logging in the electronic commerce service.

### [B4-4] Identification Process

Next, the process executed by the authentication server 30 of the present embodiment, which is the identification process to execute the electronic commerce, will be described.

The position information management unit 302 works with the transaction management server 11 and executes the identification process for identifying the supplier and the client (including the user who is assumed to become the supplier and the client in the future). when executing the authentication process or the authentication determination process.

Specifically, the position information management unit 302:
(A1) specifies the user based on the user ID transmitted from the transaction management server 11 executing the electronic commerce or the terminal device 20 when the transaction management server 11 or a dedicated server different from the terminal device 20 specifies the user; and
(A2) specifies a user based on the user ID logged in the transaction management server 11 when the transaction management server 11, which executes electronic commerce as the electronic commerce authentication system.

Specifically, the position information management unit 302 receives the user identification information (e.g., UID) of the supplier and the user identification information of the client, transmitted from the transaction management server 11 via the communication control unit 301.

The position information management unit 302 searches for the position related information storage unit 372 based on the user identification information (hereinafter referred to as “received user identification information”) of the supplier and the client.

When the position information management unit 302 detects the user identification information that matches the received user identification information and that is stored in the position related information storage unit 372, the position information management unit 312 identifies the user having the detected user identification information as the supplier or the client.

The transaction target person information is, for example, information such as a user ID registered in advance or the user ID and the user's password.

[B4.5] The authentication Determination Process

Next, the authentication determination process executed by the authentication server 30 of the present embodiment will be described.

### (Outline of Authentication Determination Process)

Each time an electronic commerce is executed, the determination processing unit 303 determines whether the supplier and the client, who are transaction users of the electronic commerce transmitted from the transaction management server 11, are the authorized party.

The determination processing unit 303 determines that the supplier and the client are the authorized party when the user is determined to be the user (including an organization such as a company) living in the real world and being a user who exists as a person who is not a member of an anti-social force.

Specifically, the determination processing unit 303 performs, as the authentication determining process:
(A1) a position information acquisition process of acquiring position difference information indicating a difference between the current position of the transaction target person and the position of the target person at a past timing, at an action execution timing or an action execution related timing; and
(A2) a condition determination process for comparing the acquired position difference information with reference distance related information of the user who becomes the transaction target person, and determining whether the result of the comparison satisfies a given user condition.

The determination processing unit 303 determines the authenticity of the specific user based on the determination result of the executed condition determination process.

Specifically, the determination processing unit 303 executes, as the condition determination process, a supplier condition determination process of executing the condition determination process of executing the condition determination process of the supplier, and a client condition determination process of executing the condition determination process of the client.

The determination processing unit 303 determines the authenticity of the supplier or the client as the transaction target person based on the determination result of the executed condition determination process.

In the case where one of the suppliers or the clients is a user whose authentication has already been determined, such as a public institution, or a user whose authentication does not need to be determined, the determination processing unit 303 may determine the authenticity of only one of the suppliers or the clients.

### (Position Information Acquisition Process)

The determination processing unit 303 acquires, from the transaction management server 11, position difference information of the user at the transaction execution timing when the electronic commerce is executed in the terminal device 20 of the user of the supplier and the client.

Specifically, the determination processing unit 303 acquires, from the transaction management server 11, a difference in latitude and longitude or a difference in distance based on the current position of the transaction execution timing of the last (i.e., immediately preceding) electronic commerce transaction and the transaction execution timing of the current electronic commerce transaction, as position difference information, for the customer (i.e., buyer).

Similarly, the determination processing unit 303 acquires the difference in latitude and longitude or the difference in distance based on the current position of the transaction execution timing of the last electronic commerce transaction and the transaction execution timing of the current electronic commerce transaction from the transaction management server 11 as the position difference information with respect to the supplier (i.e., the seller).

The determination processing unit 303 may directly acquire the position difference information from the terminal device 20 corresponding to the supplier or the client.

The determination processing unit 303 may acquire, as the position difference information, a difference between the transaction execution timing of the past electronic commerce transaction, such as the time before the previous time or the time before that, and the transaction execution timing of the current electronic commerce transaction, instead of the difference between the previous action execution timing and the current action execution timing in the position difference information.

Further, when determining the authenticity of either one of the supplier and the client, the determination processing unit 303 may acquire the position difference information of the corresponding transaction target person among the supplier and the client.

Every time the position difference information of each user is acquired, the determination processing unit 303 registers the position difference information in the position related information storage unit 372 in association with the already registered position difference information, and updates the already registered position difference information as the recorded information.

### (Supplier Condition Determination Process)

In the supplier condition determination process, the determination processing unit 303 compares the position difference information of the supplier acquired at the transaction execution timing when the electronic commerce is executed with reference distance related information registered in association with the user who is the supplier, and determines whether or not the result of the comparison satisfies the transaction target person condition (supplier condition).

Specifically, the determination processing unit 303 uses, as the transaction target person condition, for example, a condition that the distance indicated by the position difference information of the supplier within the distance range (for example, within 10 km) defined in the reference distance related information.

In the authentication determining process, the determination processing unit 303 determines that the supplier is the authorized party when the transaction target person condition is satisfied, and determines that the supplier is not the authorized party when the transaction target person condition is not satisfied.

On the other hand, when the position difference information of the transaction target person is registered in the position related information storage unit 372 at each predetermined timing, the determination processing unit 303 may execute the condition determination process based on the recorded information of the transaction target person.

In this case, the determination processing unit 303 executes the condition determination process on the basis of: the position difference information indicated by the position difference information of the transaction target person acquired at the transaction execution timing; the recorded information (position difference information) of the corresponding transaction target person (i.e., supplier) already registered in the position related information storage unit 372, and the reference distance related information registered as the supplier.

In other words, in this case, since the active position of the supplier can be continuously recognized at the time of executing the electronic commerce, the authenticity of the supplier can be determined by using the difference between the present position and the past position while taking into consideration the acquisition of the personal information.

Specifically, in this case, the determination processing unit 303 compares each piece of the position difference information of the corresponding user stored as recorded information of the supplier with reference distance related information registered in association with the user who becomes the supplier, and determines whether all comparison results satisfy a given transaction target person condition (supplier condition).

The determination processing unit 303 uses, as the transaction target person condition, for example, a condition that the position difference indicated by the position difference information of the supplier is within the distance range of the reference distance related information registered as the transaction target person.

In the case where the reference distance related information is stored for each attribute of the user, the determination processing unit 303 may specify the attribute of the transaction source based on the already registered attribute and acquire the reference distance related information based on the specified attribute when executing the condition determination process.

For example, the already registered attribute indicates an attribute specified based on information input by each user at a given timing such as when the user is registered in a commerce service.

### (Client Condition Determination Process)

In the client condition determination process, as in the supplier condition determination process, the determination processing unit 303 compares the position difference information of the client acquired at the transaction execution timing when the electronic commerce is executed with reference distance related information registered in association with the user who is the client, and determines whether or not the result of the comparison satisfies the transaction target person condition (client condition).

Specifically, the determination processing unit 303 uses, as the transaction target person condition, for example, a condition that the distance indicated by the position difference information of the client within the distance range (for example, within 10 km) defined in the reference distance related information.

In the authentication determining process, the determination processing unit 303 determines that the client is the authorized party when the transaction target person condition is satisfied, and determines that the client is not the authorized party when the transaction target person condition is not satisfied.

On the other hand, when the position difference information of the transaction target person is registered in the position related information storage unit 372 at each predetermined timing, as in the client condition determination process, the determination processing unit 303 may execute the condition determination process based on the recorded information of the transaction target person.

In this case, the determination processing unit 303 executes the client condition determination process on the basis of: the position difference information indicated by the position difference information of the transaction target person acquired at the transaction execution timing; the recorded information (position difference information) of the corresponding transaction target person (i.e., client) already registered in the position related information storage unit 372, and the reference distance related information registered as the client.

In other words, in this case, since the active position of the client can be continuously recognized at the time of executing the electronic commerce, the authenticity of the client can be determined by using the difference between the present position and the past position while taking into consideration the acquisition of the personal information.

Specifically, in this case, the determination processing unit 303 compares each piece of the position difference information of the corresponding user stored as recorded information of the client with reference distance related information registered in association with the user who becomes the client, and determines whether all comparison results satisfy a given transaction target person condition (client condition).

Similarly, the determination processing unit 303 uses, as the transaction target person condition, for example, a condition that the position difference indicated by the position difference information of the supplier is within the distance range of the reference distance related information registered as the transaction target person.

In the case where the reference distance related information is stored for each attribute of the user, the determination processing unit 303 may specify the attribute of the client based on the already registered attribute and acquire the reference distance related information based on the specified attribute when executing the client condition determination process, as in the case of the supplier condition determination process.

For example, the already registered attribute indicates an attribute specified based on information input by each user at a given timing such as when the user is registered in the commerce service, as in the case of the supplier condition determination process.

### [B4.6] Authentication Process

Next, the authentication determination process executed by the authentication server 30 of the present embodiment will be described.

The authentication processing unit 304 executes the authentication process of authenticating the electronic commerce when the supplier and the client are determined to be the authorized parties by the authentication determination process at the transaction execution timing when the electronic commerce is executed.

Specifically, the authentication processing unit 304 authenticates the electronic commerce when the supplier and the client are determined to be the authorized party by the authentication determination process, and rejects the electronic commerce without authentication the electronic commerce when the supplier or the client is determined not to be the authorized party.

When the supplier and the client are determined to be the authorized party by the authentication determination process, the authentication processing unit 304 may authenticate the corresponding electronic commerce on the assumption that the identification of the supplier and the client has been confirmed. When the supplier or the client is determined to be not the authorized party, the authentication processing unit 304 may reject the corresponding electronic commerce without authentication of the electronic commerce on the assumption that the identification of the supplier and the client cannot be confirmed. In this case, the authentication process may be used together with another authentication process of identifying the person, such as face image authentication, two step authentication, or one time password, in order to increase the accuracy of the authentication process.

### [B4-7] Provision Process

Next, the providing process of providing the result of the approval process executed by the authentication server 30 of the present embodiment to the transaction management server 11 will be described.

When the approval is rejected by the approval process, the information providing unit 311 provides the transaction management server 11 with result information indicating the result of the approval rejection by the approval process.

When the approval process succeeds in the approval, the information providing unit 311 provides the transaction management server 11 with result information indicating the result of the successful approval.

When the result information indicates that the approval has failed, the transaction management server 11 notifies the corresponding terminal device 20 of the result and terminates the corresponding electronic commerce as unsuccessful.

In the case of the result information indicating that the approval has succeeded, the transaction management server 11 establishes the electronic commerce, converts the electronic commerce information into a predetermined format, and registers the electronic commerce information in a plurality of databases 50 in a distributed manner, while notifying the terminal device 20 of the fact.

The information providing unit 311 may provide the result information of the approval process to the terminal device 20 of the corresponding user (i.e., the user of the supplier and the client) via the transaction management server 11 or directly.

When the authentication is successful by the authentication process, the information providing unit 311 provide the transaction management server 11 with the information on the assumption that the identification of the users of the supplier and client have been confirmed. In this case, when the authentication is rejected by the authentication process, the information providing unit 311 provides the transaction management server 11 with the information on the assumption that the identification of the supplier client cannot be confirmed.

### [B5] Operation of the Present Embodiment

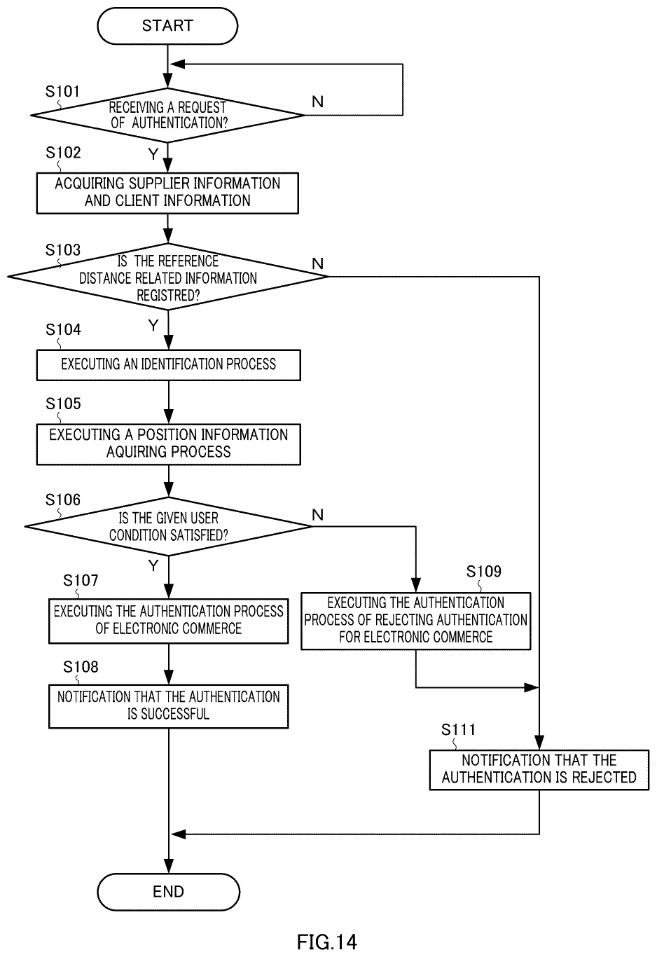

Next, the operation relating to the authentication process executed by the authentication server 30 of the present embodiment will be described with reference to FIG. 14.

FIG. 14 is a flowchart illustrating the operation of the authentication process executed by the authentication server 30 of the present embodiment.

In the operation, it is assumed that reference distance related information, which is defined as information of reference distances of a plurality of users or as information related to the distances, is registered in advance.

In this operation, it is assumed that the transaction management server 11 executes each process related to electronic commerce with the corresponding terminal device 20, and that identification information and position difference information of suppliers and clients have already been acquired from each terminal device 20.

First, when receiving an authentication request for electronic commerce from the transaction management server 11 (step S101), the position information management unit 302 acquires user identification information for identifying a supplier and a client from the transaction management server 11 as supplier's information and client's information (step S102).

Next, the position information management unit 302 searches for the position related information storage unit 372 based on the acquired user identification information, and determines whether the reference distance related information based on the user identification information is stored in the position related information storage unit 372 (step S103).

At this time, when determining that the reference distance related information is stored in the position related information storage unit 372 in association with the acquired user identification information, the position information management unit 302 proceeds to the process of the step S104.

When it is determined that the reference distance related information is not stored in the position related information storage unit 372 in association with any of the acquired user identification information, the information providing unit 311 transmits a notification to the transaction management server 11 that the authentication of the electronic commerce is rejected (step S111), and terminates the operation.

Next, when determining that the reference distance related information is stored in the position related information storage unit 372 in association with the acquired user identification information, the position information management unit 302 executes an identification process for identifying the user corresponding to the user identification information as transaction target persons of the supplier and client who execute the electronic commerce (step S104).

Next, the determination processing unit 303 executes position acquisition process of acquiring the position difference information that indicates the position difference acquired from the transaction management server 11 when executing the electronic commerce, and which the identified transaction target person has (step S105).

Next, the determination processing unit 303 compares the acquired position difference information of the transaction target person with the reference distance related information, and executes authentication determining process of determining whether the result of the comparison satisfies a transaction target person condition (step S106).

At this time, when determining that the comparison result satisfies the transaction target person condition, the determination processing unit 303 proceeds to the process of the step S107, and when determining that the comparison result does not satisfy the transaction target person condition, the determination processing unit 303 proceeds to the process of step S109.

Next, the authentication processing unit 304 executes the authentication process of authenticating the electronic commerce when the supplier and the client are determined to be the authorized parties by the authentication determination process (step S107).

Next, the information providing unit 311 transmits a notification indicating that the authentication of the corresponding electronic commerce has been successful to the transaction management server 11 (step 108), and terminates this operation.

On the other hand, when it is determined that the supplier or the client is not the authorized party, the authentication processing unit 304 executes an authentication process of rejecting the authentication without authentication of the electronic commerce (step S109).

Next, the information providing unit 311 transmits a notification indicating that the authentication of the corresponding electronic commerce has not been successful to the transaction management server 11 (step S111), and terminates this operation.

### [B6] Modification

### [B6-1] First Modification

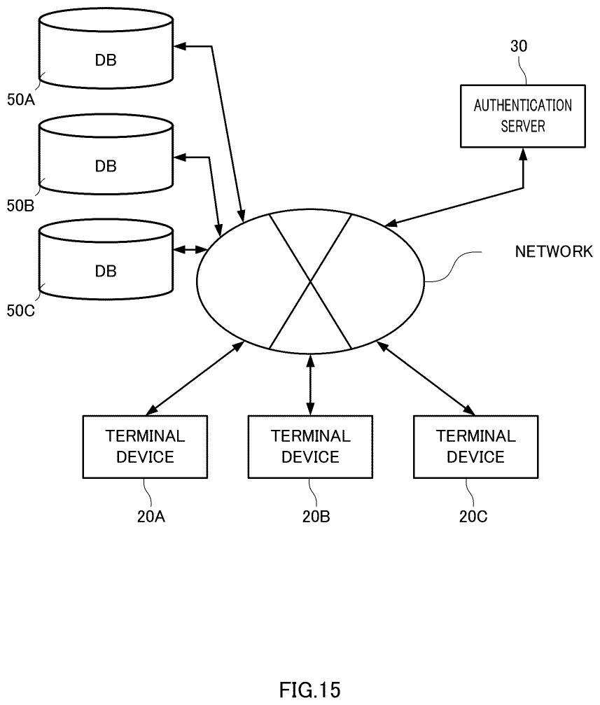

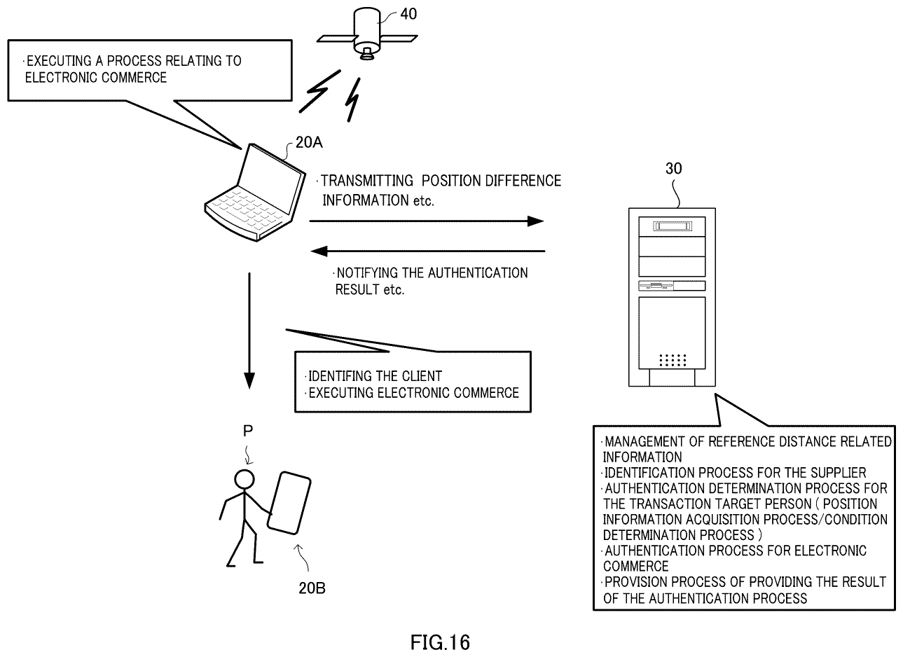

Next, a case where the execution of the above electronic commerce is executed on the terminal device 20 will be described as a first modification of the above embodiment with reference to FIGS. 15 and 16.

FIG. 15 is a system configuration diagram illustrating an electronic commerce system S12 of the present modification, and FIG. 16 is a diagram for explaining the authentication process executed by the authentication server 30 in the present modification.

As illustrated in FIGS. 15 and 16, the electronic commerce system S12 of the present modification is a system for executing the electronic commerce using a wallet application (application for a non-custodial wallet) registered in the terminal device 20.

Specifically, the electronic commerce system S12 of the present modification is an effective system when a malicious third party masquerades as a legitimate user and executes the electronic commerce using the terminal device 20.

As illustrated in FIG. 15, the electronic commerce system S12 of the present modification is configured by the terminal devices 20 (for example, terminal devices 20A, 20B, and 20C) that directly executes the electronic commerce with another terminal device 20, and the authentication server 30 that executes each process for authenticating the electronic commerce.

Specifically, the terminal device 20 transmits the position difference information as the supplier to the authentication server 30, and executes a process relating to electronic commerce with another terminal device 20 of the client when the terminal device 20 is authenticated as the supplier.

At this time, the authentication server 30 has a configuration for managing distance reference information of the supplier, which is information registered in advance.

The authentication server 30 is configured to identify a transaction target person as the supplier of the electronic commerce, based on the transaction target person information, the supplier, transmitted from the terminal device 20 which executes the electronic commerce.

As illustrated in FIG. 16, the authentication server 30 is configured to execute:
(A1) the authentication determination process of determining authenticity of the transaction target person (supplier) when the electronic commerce is executed;
(A2) the authentication process of authenticating the electronic commerce based on a result of the authentication determination process at the transaction execution timing; and
(A3) the provision process of providing the result of the authentication process to the terminal device 20 of the specific user.

Specifically, the authentication server 30 executes the authentication determining process as in the above embodiment, and the authentication determining process based on the result of the determination of the executed condition determination process. The authentication determining process includes:
(A2-1) a position information acquisition process of acquiring position difference information indicating a difference between a current position of the transaction target person at a timing corresponding to a transaction execution timing or the transaction execution related timing related to the transaction execution timing and a position of the transaction target person at a past timing; and
(A2-2) a condition determination process of comparing the acquired position difference information with the reference distance related information of the user who becomes the transaction target person, and determining whether the result of the comparison satisfies a given user condition.

FIG. 16 shows an example of the terminal devices 20A and 20B that acquire position difference information specified from position information based on a GPS signal transmitted from the GPS satellite 40, transmit the acquired position difference information to the authentication server 30, and receive a result of the authentication process.

Further, FIG. 16 shows an example in which a laptop is used as the terminal device 20A of the supplier and a smartphone owned by the user P is used as the terminal device 20B of the client.

FIG. 16 shows an example of the authentication server 30 that executes a registration request for the reference distance related information transmitted from the terminal device 20A, management of the position difference information based on the current position of the terminal device 20A, the identification process of the supplier, the authentication determination process (the position information acquisition process and the condition determination process), the authentication process of authenticating the electronic commerce, and the provision process of providing the result of the authentication process.

### [B6-2] Second Modification

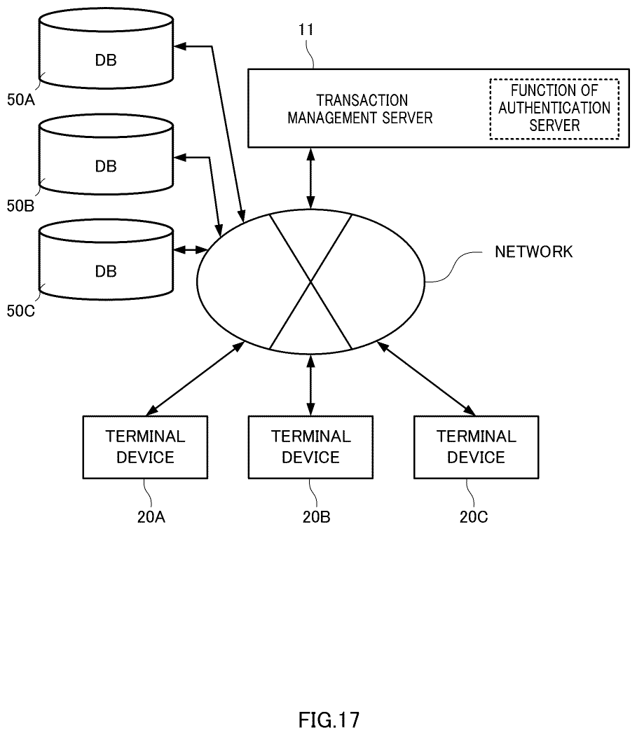

Next, a case where the transaction management server 11 has the respective functions of the authentication server 30 in the above embodiment will be described as a second modification of the present embodiment with reference to FIG. 17.

FIG. 17 is a system configuration diagram illustrating an embodiment of an electronic commerce system S13.

The transaction management server 11 of the present modification has a configuration for executing: the authentication determination process of determining the authenticity of a supplier or a client when executing a process relating to the electronic commerce by the supplier and the client using user-related information relating to a managed user; and an authentication process of authenticating the electronic commerce.

Specifically, the transaction management server 11 is configured to manage the distance reference of the supplier or the client information which is information registered in advance.

As illustrated in FIG. 17, the transaction management server 11 is configured to executes:
(A1) a transaction process of executing process relating to electronic commerce by a supplier and a client;
(A2) authentication determination process of determining whether at least one of the supplier and the client when the electronic commerce is executed satisfies a given transaction subject condition;
(A3) an authentication process of authenticating the electronic commerce based on the result of the authentication determination process; and
(A4) a registration process of the registering the electronic commerce information of the authenticated electronic commerce in a plurality of databases in a distributed manner.

Specifically, the transaction management server 11 executes as the authentication determining process as in the above embodiment:
(A2-1) a position information acquisition process of acquiring position difference information indicating a difference between a current position of the transaction target person at a timing corresponding to a transaction execution timing or the transaction execution related timing related to the transaction execution timing and a position of the transaction target person at a past timing; and
(A2-2) a condition determination process of comparing the acquired position difference information with the reference distance related information of the user who becomes the transaction target person, and determining whether the result of the comparison satisfies a given user condition.

### [B6-3] Third Modification

Next, a case where the execution of the authentication process of the electronic commerce when the authenticity of the user is determined in advance before the execution of the commercial transaction, and the authentication process of the commercial transaction is executed based on the result of the determination, will be described as a third modification of the above embodiment,

### (Characteristics of Present Modification)

The present modification is characterized in that, the authentication determination process is executed at a timing corresponding to a transaction execution timing such as before or a timing after the execution of the electronic commerce action, and the authentication process is executed based on the result of the authentication determination process, instead of executing the authentication determination process and the authentication process based on the position difference information of the supplier and the client when executing the electronic commerce in the above embodiment.

The authentication server 30 of the present modification has a configuration for determining the authenticity of a user who can be a supplier or a client before executing the electronic commerce based on the position difference information of the user acquired at a given timing or at each predetermined timing.

Specifically, the authentication server 30:
(A1) executes the position information acquisition process of acquiring position difference information indicating a difference between the current position of the transaction target person and the position of the transaction target person at a past timing, at each timing corresponding to a predetermined timing, as a transaction execution related timing;
(A2) registers the acquired position difference information in the position related information storage unit 372 as recorded information of the corresponding user; and
(A3) executes the authentication determination process of comparing the recorded information of the transaction target person with the registered reference distance related information of the user as the transaction target person, and of determining whether the comparison result satisfies the transaction target person condition, at least one of before and after the electronic commerce is executed.

Specifically, the recitation “before the electronic commerce is executed” indicates the timing when the user logs in the electronic commerce service (i.e., the transaction management server 11) for executing the electronic commerce, or a predetermined timing (a predetermined time such as 0:00 every day). Note that the timing is not limited to the timing before the execution timing of the electronic commerce.

The authentication server 30 holds the result of the authentication determination process, and executes the authentication process based on the result of the authentication determination process when the electronic commerce is executed.

On the other hand, the recitation “after the electronic commerce is executed” indicates, for example, the timing when the amount of trading (for example, as a legal currency) of the virtual currency (i.e., the transaction object) is determined after the purchase of the virtual currency is executed as the electronic commerce in the case of purchasing the virtual currency.

Further, “after the electronic commerce is executed” indicates, in the case where the electronic commerce is a lottery or auction transaction, or where the electronic commerce is finalized after the application under the tentative conditions is made (for example, the purchase of the shares after the application for book building such as at the time of initial public offering of the shares), the timing of winning the lottery or auction, the timing of winning the auction, or the timing of finalizing the electronic commerce after the application under the tentative conditions is made, assuming that the application under the tentative conditions is the execution of the electronic commerce.

### [B6-4] Fourth Modification

Next, as a fourth modification of the above embodiment, a case where the position difference information of the user is acquired in the above embodiment or the above modifications, the time when the position difference information is acquired is specified, and the time information indicating the time is used for the authentication determination process will be described.

The authentication server 30 of the present modification has a configuration for acquiring the position difference information of the user at the transaction execution timing, the transaction execution related timing, or at each transaction execution related timing, and at that time, specifying the time when the position difference information is acquired.

The authentication server 30 of the present modification has a configuration for executing authentication determination process based on each piece of position difference information including time information indicating the specified time.

Specifically, when the authentication determination process of the supplier or the client is executed using the time information of the position difference information, the determination processing unit 303 determines whether the moving speed or acceleration of the supplier or the client is consistent.

For example, the determination processing unit 303 calculates the moving speed or acceleration of the transaction target person based on the time information associated with the previous position difference information, the time information associated with the position difference information acquired this time, and the distance between the two points of the previous and current position difference information.

The determination processing unit 303: determines whether or not the calculated moving speed or acceleration is within a predetermined range on the transaction target person condition that the comparison result between the position difference information and the reference distance related information of the above embodiment; and determines that the supplier or the client is the authorized party when the calculated moving speed or acceleration is within the predetermined range.

Specifically, the determination processing unit 303 determines whether the calculated moving speed or acceleration is equal to or less than a reference moving speed or acceleration (i.e., reference speed or reference acceleration) associated with the reference distance related information.

The determination processing unit 303 determines that the supplier or the client is the authorized party when the calculated moving speed or acceleration is equal to or less than the reference moving speed or reference acceleration.

The time information of the present modification indicates information of a term when the distance difference of the position difference information occurs (hereinafter, referred to as “position difference period”), instead of the time information of the time when the position difference information is acquired.

The information may be the information of the position difference period from the time information associated with the previous position difference information to the time information associated with the position difference information acquired this time.

In this case, the position difference period is also used when calculating the moving speed or acceleration of the transaction target person, as described above.

[B6-5] Fifth Modification Next, a description will be given of a case where the electronic commerce is executed based on the result of the authentication determination process without executing the authentication process in the fifth modification of the above embodiment.

The authentication server 30 of the present modification has a configuration in which, when it is determined that the supplier, the client, or both are the authorized parties, the result is provided to the transaction management server 11 or the terminal device 20 that executes the electronic commerce.

Specifically, the authentication server 30 is configured to manage reference distance related information of the supplier, which is information registered in advance.

The authentication server 30 is configured to identify a transaction target person as the supplier of the electronic commerce, based on the transaction target person information, the supplier, transmitted from the transaction management server 11 or the terminal device 20 which executes the electronic commerce.

The authentication server 30 is configured to execute:
(A1) the authentication determination process of determining authenticity of the transaction target person (supplier) when the electronic commerce is executed; and
(A2) the provision process of providing the determination result of the authentication determination process to the transaction management server 11 or the terminal device 20 at the transaction execution timing.

Specifically, the authentication server 30 executes the authentication determining process as in the above embodiment, and the authentication determining process based on the result of the determination of the executed condition determination process. The authentication determining process includes:
(A2-1) a position information acquisition process of acquiring position difference information indicating a difference between a current position of the transaction target person at a timing corresponding to the transaction execution timing or the transaction execution related timing, and a position of the transaction target person at a past timing; and
(A2-2) a condition determination process of comparing the acquired position difference information with the reference distance related information of the user who becomes the transaction target person, and determining whether the result of the comparison satisfies a given user condition.

### [B6-6] Sixth Modification

Next, as a sixth modification of the above embodiment, a case where the authentication process of the electronic commerce is used for login process in the above embodiment or modification will be described.

The authentication server 30 of the present modification is configured to execute the authentication process of authenticating the login to the electronic commerce service based on the determination result of the authentication determination process at a login execution timing when a user logs in to the electronic commerce service that causes the user to execute electronic commerce.

Specifically, the authentication server 30 of the present modification is configured to:
(A1) acquire, at a timing when the transaction target person logged in to the electronic commerce service, as the position information acquisition process, the position difference information indicating a difference between a current position of the transaction target person and a position of the transaction target person user at a past timing (for example, a timing at which the transaction target person logs in to the electronic commerce in the past), and
(A2) execute the authentication determination process of comparing the acquired position difference information with the registered reference distance related information of the user when the login is executed, and determining whether the comparison result satisfies the user condition.

The authentication server 30 of the present modification may execute the authentication determination process at a timing related to the execution of login, such as before the user logs in to the electronic commerce service.

In this case, the authentication server 30 of the present modification may acquire the position difference information at another timing, such as a timing when the user is not logged in to the electronic commerce service.

### [B6-7] Seventh Modification

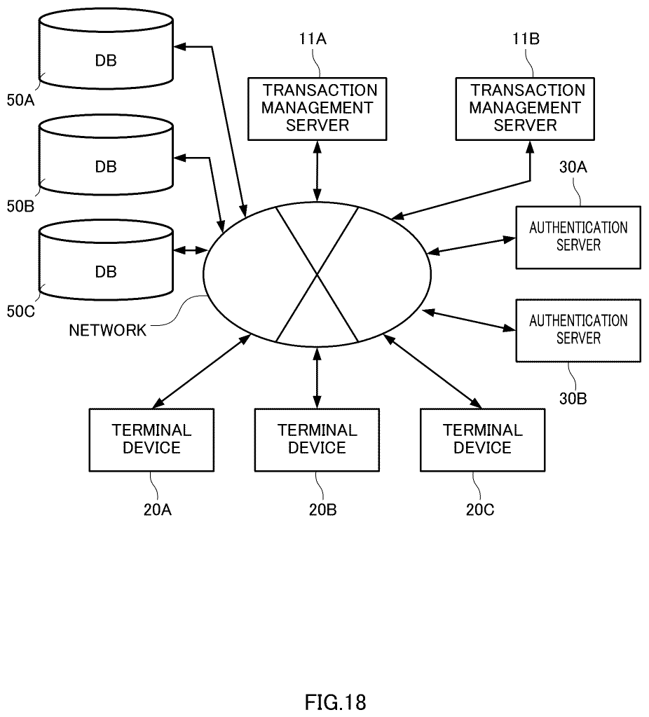

Next, an electronic commerce system S14 is configured by a plurality of servers according to a seventh modification of the present embodiment will be described with reference to FIG. 18.

FIG. 18 is a system configuration of an electronic commerce system S14 in the seventh modification of the embodiment.

In the above embodiment or the above modification, the electronic commerce system S13 may be constituted by a plurality of transaction management servers 11 or a plurality of authentication servers 30.

In other words, when the electronic commerce system S11 is configured by the plurality of transaction management servers 11, the electronic commerce system S14 includes the supplier and the terminal devices 20 and the transaction management servers 11A and 11B for executing the process relating to the supplier, as illustrated in FIG. 18.

The transaction management server 11A and the transaction management server 11B establish a communication line through the network N and perform various processes in conjunction with each other to perform various processes related to the electronic commerce.

In the case where the electronic commerce system S14 is configured by the plurality of authentication servers 30, the electronic commerce system S14 has authentication servers 30A and 30B for executing the authentication process of the supplier or the client in conjunction with the transaction management servers 11A and 11B for executing process of the supplier and the client, as illustrated in FIG. 18.

### [C] Other

The present invention is not limited to those in the above-described embodiments, and various modifications and variations can be made. For example, words cited as broadly or synonymously in the description or drawings may be replaced by broadly or synonymously in the description or drawings.

The present invention includes substantially the same configuration as the configuration described in the embodiment (for example, configuration with the same function, method and result, or configuration with the same purpose and effect). The present invention also includes a configuration in which non-essential parts of the configuration described in the embodiment are replaced. The present invention also includes a configuration that achieves the same effects as the configuration described in the embodiment or a configuration that can achieve the same purpose. The present invention also includes a configuration obtained by adding a known technique to the configuration described in the above embodiment.

Although the present embodiments of the present invention have been described in detail as described above, it will be readily apparent to those skilled in the art that many variations are possible without departing materially from the new matter and effect of the present invention. Accordingly, all such modifications are intended to be within the scope of the present invention.

### REFERENCE SIGNS LIST

S: Electronic commerce system
S1, S2, S3, S4: Network service provision system
S11, S12, S13, S14: Electronic commerce system
10: Service management servers
11: Transaction management servers
20: Terminal device
30: Authentication server
40: GPS satellite
50: Database
100: Processing unit
101: Communication control unit
102: Service providing management control unit
103: User information management control unit
105: Electronic commerce management control unit
110: Timer management unit
170: Storage unit
171: Main storage unit
172: User information storage unit
180: Information storage medium
196: Communication unit
300: Processing unit
301: Communication control unit
302: Position information management unit
303: Determination processing unit
304: Authentication processing unit
310: Timer management unit
311: Information providing unit
312: Position information management unit
370: Storage unit
371: Main storage unit
372: Position related information storage unit
380: Information storage medium
396: Communication unit

1. An authentication system for authenticating a given action when a user is enabled to receive a given network service, comprising one or more processors and one or more memories, the processor programmed to:
manage reference distance related information, which is information registered in advance in a storage unit, and in which a reference distance for authenticating an execution of the action by the user or information related to the reference distance is defined;
identify a user who instructs the execution of the action as a specific user based on user information relating to a user who executes the action when the action is executed;
execute a determination process of determining whether the specific user when the action is executed satisfies a given user condition; and
execute an authentication process of authenticating the execution of the action based on a result of the determination process at an action execution timing at which the action is executed,
wherein the processor programmed to execute, as the determination process including:
a position information acquisition process of acquiring difference information at an action execution timing or an action execution related timing related to the action execution timing, the difference information indicating a difference between a current position of the specific user at the action execution timing or the action execution related timing and a position of the specific user at a past timing; and
a condition determination process of comparing the acquired difference information and the reference distance related information, and of determining whether the result of the comparison satisfies a given user condition.

2. The authentication system according to claim 1, wherein
the processor is programmed to:
acquire difference information indicating a difference between the current position of the specific user and the position of the specific user at a past timing, at each timing corresponding to a predetermined timing, as the position information acquisition process;
register the acquired difference information in a storage unit as recorded information of the corresponding user; and
execute the condition determination process of comparing the recorded information of the specific user with the reference distance related information, and of determining whether the comparison result satisfies the user condition.

3. The authentication system according to claim 1, wherein
the processor is programmed to:
acquire difference information indicating a difference between the current position of the specific user and the position of the specific user at a past timing, at each timing predetermined as an action execution related timing, as the position information acquisition process;
register the acquired difference information in a storage unit as recorded information of the corresponding user; and
execute the condition determination process of comparing the recorded information of the specific user with the reference distance related information, and of determining whether the comparison result satisfies the user condition, before the action execution timing or a timing after the action is executed.

4. The authentication system according to claim 1, wherein
the processor is programmed to execute the determination process of determining authenticity of the specific user when the action is executed based on the determination result of the condition determination process as the determination process.

5. The authentication system according to claim wherein
the processor is programmed to:
acquire, as the position information acquisition process, time information indicating a time at the action execution timing or the action execution related timing when the difference information is acquired; and
determine, as the condition determination process, whether the difference information based on the time information satisfies the user condition with respect to the reference distance related information.

6. The authentication system according to claim 1, wherein the processor is programmed to
provide the user with an execution result of the action.

7. The authentication system according to claim 1, wherein
in the case where an electronic commerce is executed as the action, and the reference distance related information has: information of a distance serving as a reference for authenticating the electronic commerce; or information related to the distance,
the processor is programmed to:
identify, as the specific user, a transaction target person who conducts the electronic commerce based on transaction target person information that relates to a transaction target person who is at least one user of a supplier and a client of the electronic commerce, and that is transmitted from an information processing device executing the electronic commerce;
execute the authentication process of authenticating the electronic commerce between the identified supplier and the client based on the determination result of the determination process at a transaction execution timing at which the electronic commerce is executed as the action execution timing ;
execute the information acquisition process of acquiring position difference information indicating a difference between a current position of the transaction target person at a timing corresponding to the transaction execution timing or a transaction execution related timing related to the transaction execution timing and a position of the transaction target person at a past timing, at the transaction execution timing or the transaction execution related timing; and
compare the acquired position difference information with the reference distance related information and execute the condition determination process of determining whether the result of the comparison satisfies a transaction target person condition that indicates the user condition.

8. The authentication system according to claim 7, wherein
the processor is programmed to:
acquire, as the difference information, position difference information indicating a difference between the current position of the transaction target person and the position of the transaction target person at a past timing, every timing predetermined as the transaction execution related timing, as the position information acquisition process;
register the acquired position difference information in a storage unit as recorded information of the corresponding transaction target person; and
execute the condition determination process of comparing the recorded information of the transaction target person with the reference distance related information, and of determining whether the comparison result satisfies the transaction target person condition.

9. The authentication system according to claim 7, wherein
the processor is programmed to register the information relating to the electronic commerce as electronic commerce information in a plurality of databases in a distributed manner, and
the electronic commerce information is formed by block information which is blocked based on a plurality of pieces of electronic commerce information including the electronic commerce information and a hash value determined from past commercial transaction information when the electronic commerce is authenticated.

10. (canceled)

11. (canceled)

12. (canceled)

13. (canceled)

14. A user authorization system for executing determination relating to a user for a given action when a user is enabled to receive a given network service, comprising one or more processors and one or more memories, the processor programmed to:
manage reference distance related information, which is information registered in advance in a storage unit and in which a reference distance for authenticating an execution of the action by the user or information related to the reference distance is defined;
identify a user who instructs the execution of the action as a specific user based on user information relating to a user who executes the action when the action is executed;
execute a determination process of determining whether the specific user when the action is executed satisfies a given user condition; and
provide a determination result of the determination process to an information processing device,
wherein the processor is programmed to execute:
a position information acquisition process of acquiring difference information at an action execution timing or an action execution related timing related to the action execution timing, the difference information indicating a difference between a current position of the specific user at the action execution timing or the action execution related timing and a position of the specific user at a past timing; and
a condition determination process of comparing the acquired difference information and the reference distance related information, and of determining whether the result of the comparison satisfies a given user condition.

15. The user authorization system according to claim 14, wherein
in the case where an electronic commerce is executed as the action, and the reference distance related information has: information of a distance serving as a reference for authenticating the electronic commerce; or information related to the distance,
the processor is programmed to:
identify a transaction target person who conducts the electronic commerce based on transaction target person information that relates to a transaction target person who is at least one user of a supplier and a client of the electronic commerce, and that is transmitted from an information processing device executing the electronic commerce as the specific user;
execute the authentication process of authenticating the electronic commerce between the identified supplier and the client based on the determination result of the determination process at a transaction execution timing at which the electronic commerce is executed as the action execution timing;
execute the information acquisition process of acquiring position difference information indicating a difference between a current position of the transaction target person at a timing corresponding to the transaction execution timing or a transaction execution related timing related to the transaction execution timing and a position of the transaction target person at a past timing, at the transaction execution timing or the transaction execution related timing; and
compare the acquired difference information with the reference distance related information and execute the condition determination process of determining whether the result of the comparison satisfies a transaction target person condition that indicates the user condition.

16. (canceled)

17. An authentication system for executing authentication to log in to a given network service for a user, comprising one or more processors and one or more memories, the processor programmed to:
manage reference distance related information, which is information registered in advance in a storage unit and in which a reference distance for authenticating login of the user or information related to the reference distance is defined;
identify a user who instructs the execution of the action as a specific user based on user information relating to a user who executes the login;
execute a determination process of determining whether the specific user when the login is executed satisfies a given user condition; and
execute an authentication process of authenticating the execution of the login based on a result of the determination process at a login execution timing at which the login is executed,
wherein the processor is programmed to execute the determination process including:
a position information acquisition process of acquiring difference information at a login execution timing or a login execution related timing related to the login execution timing, the difference information indicating a difference between a current position of the specific user at the login timing or the login execution related timing and a position of the specific user at a past timing; and
a condition determination process of comparing the acquired difference information and the reference distance related information, and of determining whether the result of the comparison satisfies a given user condition.

18. (canceled)
